(19) United States
(12) Patent Application Publication
(10) Pub. No.: US 2009/0295911 A1
(43) Pub. Date: Dec. 3, 2009

(54) Identifying a Locale for Controlling Capture of Data by a Digital Life Recorder Based on Location

(75) Inventors: Clifton E. Grim, III, Seabrook, TX (US); Mark B. Stevens, Houston, TX (US); Gary A. Ward, Seabrook, TX (US); John David Wilson, Houston, TX (US)

Correspondence Address: DUKE W. YEE, YEE AND ASSOCIATES, P.C., P.O. BOX 802333, DALLAS, TX, 75380, US

(73) Assignee: INTERNATIONAL BUSINESS MACHINES CORPORATION, Armonk, NY (US)

(21) Appl. No.: 12/130,549

(22) Filed: May 30, 2008

(51) Int. Cl. H04N 7/18

(52) U.S. Cl. 348/61; 386/E05.024

(57) ABSTRACT

The illustrative embodiments described herein provide a computer implemented method, apparatus, and computer program product controlling a capture of data. In one embodiment, the process identifies a location from locale identifier data to form an identified location in response to receiving the locale identifier data. The locale identifier data is associated with a location of the digital life recorder. In addition, the identified location is associated with a set of usage policies. The process then determines whether the set of usage policies restricts the capture of data by the digital life recorder at the identified location or whether the set of usage policies restricts playback of the data by a playback system. Thereafter, the process disables a set of sensors while the digital life recorder is in the presence of the locale identifier in response to determining that the set of usage policies restricts the capture of data.

### BACKGROUND OF THE INVENTION

1. Field of the Invention

The present invention relates generally to an improved data processing system and in particular to a method and apparatus for controlling the operation of a digital life recorder. Still more particularly, the present invention relates to a computer implemented method, apparatus, and computer program product for implementing a locale identifier and an associated locale identifier sensor for controlling a capture of data by sensing components of a digital life recorder.

2. Description of the Related Art

Advancements in technology have drastically changed the way people do things. Gone are the days of printed encyclopedias. These paper based resources have been replaced by a plethora of information readily available on the World Wide Web. Instead of taking a roll of film to a photo shop to be developed, digital images are stored on computers, laptops, and even in digital photo frames. Additionally, because taking a digital picture does not cost anything, more digital photos are taken than was previously taken by conventional means. The photos represent memories of special or even obscure events. However, searching for a particular photo out of the hundreds or thousands of images stored on a computer is a difficult task. In addition, numerous events in our daily lives are never captured on film. Furthermore, photos do not capture the spoken words, feelings, or environmental factors associated with everyday activities.

Accordingly, there exists a need for a mechanism for dynamically capturing, storing, and presenting data associated with all aspects of daily activities in an efficient manner.

### SUMMARY OF THE INVENTION

The illustrative embodiments described herein provide a computer implemented method, apparatus, and computer program product for managing data. In one embodiment, the process identifies a location from locale identifier data to form an identified location in response to receiving the locale identifier data. The locale identifier data is associated with a location of the digital life recorder. In addition, the identified location is associated with a set of usage policies. The process then determines whether the set of usage policies restricts the capture of data by the digital life recorder at the identified location or whether the set of usage policies restricts playback of the data by a playback system. Thereafter, the process disables a set of sensors while the digital life recorder is in the presence of the locale identifier in response to determining that the set of usage policies restricts the capture of data.

### BRIEF DESCRIPTION OF THE DRAWINGS

FIG. 1 is a pictorial representation of a network of data processing systems in which illustrative embodiments may be implemented;

FIG. 2 is a block diagram of a data processing system in which illustrative embodiments may be implemented;

FIG. 3 is a diagram of components for a digital life recorder in accordance with an illustrative embodiment;

FIG. 4 is a diagram of components in a sensing subsystem in accordance with an illustrative embodiment;

FIG. 5 is a block diagram illustrating the data flow between components of a sensing subsystem and the components of a recording subsystem in accordance with an illustrative embodiment;

FIG. 6 is a block diagram illustrating the relationship between a recording subsystem and the components of a repository subsystem in accordance with an illustrative embodiment;

FIG. 7 is a block diagram illustrating the relationship between components of a network data sharing subsystem in accordance with an illustrative embodiment;

FIG. 8 is a block diagram illustrating the components of a playback subsystem in accordance with an illustrative embodiment;

FIG. 9 is a user interface associated with a playback subsystem in accordance with an illustrative embodiment;

FIG. 10 is a diagram depicting a data model in accordance with an illustrative embodiment;

FIG. 11 is a block diagram showing the operation of a digital life recorder in an identified location in accordance with an illustrative embodiment;

FIG. 12 is a flowchart of a process for controlling the operation of a digital life recorder in an identified location in accordance with an illustrative embodiment;

FIG. 13 is a flowchart of a process for capturing data of a locale identifier in accordance with an illustrative embodiment;

FIG. 14 is a high-level flowchart of a process for capturing, storing, and presenting data in accordance with an illustrative embodiment;

FIG. 15 is a flowchart of a process for capturing life data in accordance with an illustrative embodiment;

FIG. 16 is a flowchart of a process for improving the indexing of the stored data by tagging life data objects in accordance with an illustrative embodiment;

FIG. 17 is a flowchart of a process for preprocessing raw recorded data in accordance with an illustrative embodiment;

FIG. 18 is a flowchart of a process for creating a unique identifier for indexing and storing data objects in accordance with an illustrative embodiment;

FIG. 19 is a flowchart of a process for archiving data objects in accordance with an illustrative embodiment;

FIG. 20 illustrates different processes for adding commands to a command queue in accordance with an illustrative embodiment;

FIG. 21 is a flowchart of a process for processing commands in accordance with an illustrative embodiment;

FIG. 22 is a flowchart illustrating a process for acquiring and organizing personal device data in accordance with an illustrative embodiment;

FIG. 23 is a flowchart of a process for acquiring and organizing personal network data in accordance with an illustrative embodiment;

FIG. 24 is a flowchart of a process for acquiring and organizing data from the internet in accordance with an illustrative embodiment;

FIG. 25 is a flowchart of a process for acquiring and organizing data from business networks in accordance with an illustrative embodiment;

FIG. 26 is a flowchart of a process for acquiring and organizing data from infrastructure networks in accordance with an illustrative embodiment;

FIG. 27 is a flowchart of a process for improving the indexing of data stored in the repository mass store in accordance with an illustrative embodiment;

FIG. 28 is a flowchart of a process for searching, retrieving, and rendering data in accordance with an illustrative embodiment; and

FIG. 29 is a flowchart of a process for organizing and presenting data in accordance with an illustrative embodiment.

### DETAILED DESCRIPTION OF THE PREFERRED EMBODIMENT

As will be appreciated by one skilled in the art, the present invention may be embodied as a system, method, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media, such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including, but not limited to wireless, wireline, optical fiber cable, RF, etc.

Computer program code for carrying out operations of the present invention may be written in any combination of one or more programming languages, including an object oriented programming language, such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

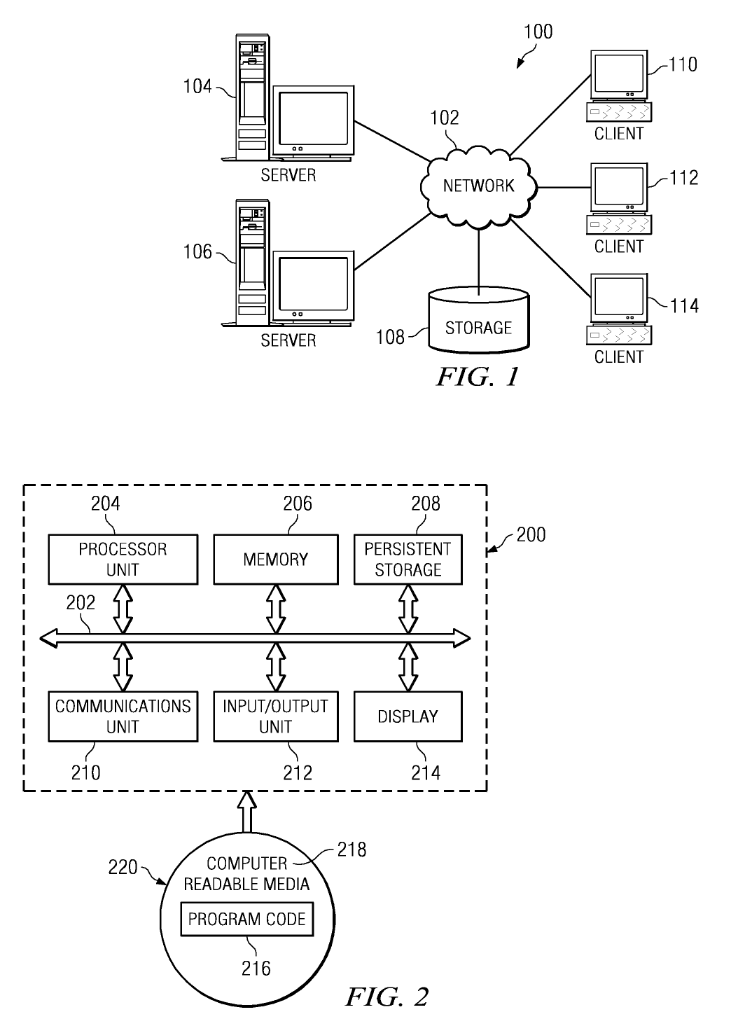

With reference now to the figures, and in particular, with reference to FIGS. 1 and 2, exemplary diagrams of data processing environments are provided in which illustrative embodiments may be implemented. It should be appreciated that FIGS. 1 and 2 are only exemplary and are not intended to assert or imply any limitation with regard to the environments in which different embodiments may be implemented. Many modifications to the depicted environments may be made.

FIG. 1 depicts a pictorial representation of a network of data processing system in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

The illustrative embodiments may be used as a digital life recorder for capturing still images, video, audio, biometric information, and other types of data associated with the daily activities of a person. The activities may be recorded on a continuous basis or may be periodically captured. For example, FIG. 1 depicts a recording subsystem 116. Recording subsystem 116 receives data captured from a plurality of data capturing devices. The data capturing devices may include, but are not limited to, video cameras. The captured data is processed by a mobile device associated with the person and is stored as raw data within a cache of the mobile device. Upon interfacing with a repository mass store, such as client 110, the stored data within the cache of the mobile device is uploaded to the repository mass store. Client 110 manages the data within the repository mass store and presents the data in response to a user request. Additional details of recording subsystem 116 and the repository mass store will be described below.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer-usable program code or instructions implementing the processes may be located for the illustrative embodiments. Data processing system 200 may also be implemented as a computing device on-board an electric vehicle, such as electric vehicle 116 in FIG. 1.

In this illustrative example, data processing system 200 includes communications fabric 202, which provides communications between processor unit 204, memory 206, persistent storage 208, communications unit 210, input/output (I/O) unit 212, and display 214. Processor unit 204 serves to execute instructions for software that may be loaded into memory 206. Processor unit 204 may be a set of processors. As used herein, the term “set” may refer to one or more. Thus, a set of processors may be one or more processors. In addition, processor unit 204 may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be, for example, a random access memory or any other suitable volatile or non-volatile storage device. Persistent storage 208 may take various forms depending on the particular implementation. For example, persistent storage 208 may contain one or more components or devices. In another example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer-usable program code, or computer-readable program code that may be read and executed by a processor in processor unit 204. The program code in the different embodiments may be embodied on different physical or tangible computer-readable media, such as memory 206 or persistent storage 208.

Program code 216 is located in a functional form on computer-readable media 218 that is selectively removable and may be loaded onto or transferred to data processing system 200 for execution by processor unit 204. Program code 216 and computer-readable media 218 form computer program product 220 in these examples. In one example, computer-readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer-readable media 218 also may take the form of a persistent storage, such as a hard drive, a thumb drive, or a flash memory that is connected to data processing system 200. The tangible form of computer-readable media 218 is also referred to as computer-recordable storage media. In some instances, computer-recordable media 218 may not be removable.

Alternatively, program code 216 may be transferred to data processing system 200 from computer-readable media 218 through a communications link to communications unit 210 and/or through a connection to input/output unit 212. The communications link and/or the connection may be physical or wireless in the illustrative examples. The computer-readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

As one example, a storage device in data processing system 200 is any hardware apparatus that may store data. Memory 206, persistent storage 208, and computer-readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache, such as found in an interface and memory controller hub that may be present in communications fabric 202.

A digital life recorder system enables users to capture data describing the totality of events that occur while the digital life recorder system is in operation. Without a mechanism for controlling the sensors of a digital life recorder system, possibilities arise where sensitive, confidential, private, or proprietary audio or video data may be collected and stored. For example, users of a digital life recorder system attending a concert may record songs of musicians in violation of their intellectual property rights. In addition, users of a digital life recorder system may wish to keep confidential details of a contract negotiation private.

Thus, the illustrative embodiments described herein provide a computer implemented method, apparatus, and computer program product for controlling the operation of a digital life recorder. In one embodiment, the process identifies a location from locale identifier data to form an identified location in response to receiving the locale identifier data. The locale identifier data is associated with a location of the digital life recorder. In addition, the identified location is associated with a set of usage policies. The process then determines whether the set of usage policies restricts the capture of data by the digital life recorder at the identified location or whether the set of usage policies restricts playback of the data by a playback system. Thereafter, the process disables a set of sensors while the digital life recorder is in the presence of the locale identifier in response to determining that the set of usage policies restricts the capture of data.

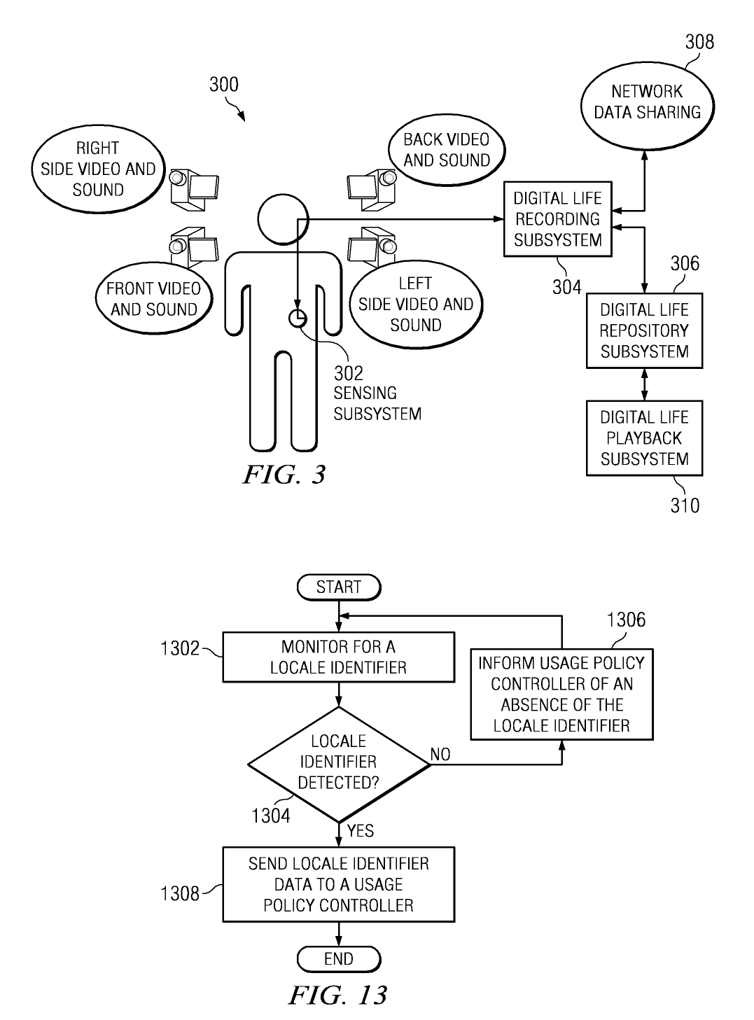

With reference now to FIG. 3, a diagram of components for a digital life recorder is depicted in accordance with an illustrative embodiment. In this example, digital life recording system 300 comprises of a sensing subsystem 302, a digital life recording subsystem 304, digital life repository subsystem 306, network data sharing 308, and digital life playback subsystem 310. Sensing subsystem 302 and digital life recording subsystem 304 may be implemented in a recording subsystem, such as recording subsystem 116 as shown in FIG. 1. Digital life repository subsystem 306, network data sharing 308, and digital life playback subsystem 310 may be implemented in a data processing system, such as data processing system 200 as shown in FIG. 2 and client 110 as shown in FIG. 1.

Sensing subsystem 302 comprises of data capturing devices for capturing data. The data capturing devices may comprise, for example, without limitation video capturing devices, audio capturing devices, biometric capturing devices, global positioning devices, environmental sensor devices, and other suitable devices for digital life recording. The data captured by the devices of sensing subsystem 302 is referred to as digital life recording data.

As depicted in FIG. 3, the video capturing devices are positioned on the person to capture a 360-degree field of view around the person. Additionally, a set of audio capturing devices may be positioned around the person. A set of biometric sensors captures physiological data associated with the person, such as, but not limited to, the heart rate of the person. A set, as referenced herein, may be comprised of one or more objects. Global positioning system devices coupled to the person captures the location and the precise time that data is captured. A set of environmental sensor devices captures environmental variables, such as, but not limited to, temperature, wind speed, barometric pressure, and humidity. In addition, the set of environmental sensor devices may detect environmental hazards, such as, but not limited to, detecting the electric field, radiation, and carbon monoxide. Other data capturing devices that may associated with the person may include, but are not limited to, medical devices, cellular telephones, and radio-frequency identification devices.

The data capturing devices for capturing data may be hidden in common apparel, such as glasses, a hat, clothing, or jewelry. In another illustrative embodiment, some or all of the capturing devices may be medically implanted into the person's body.

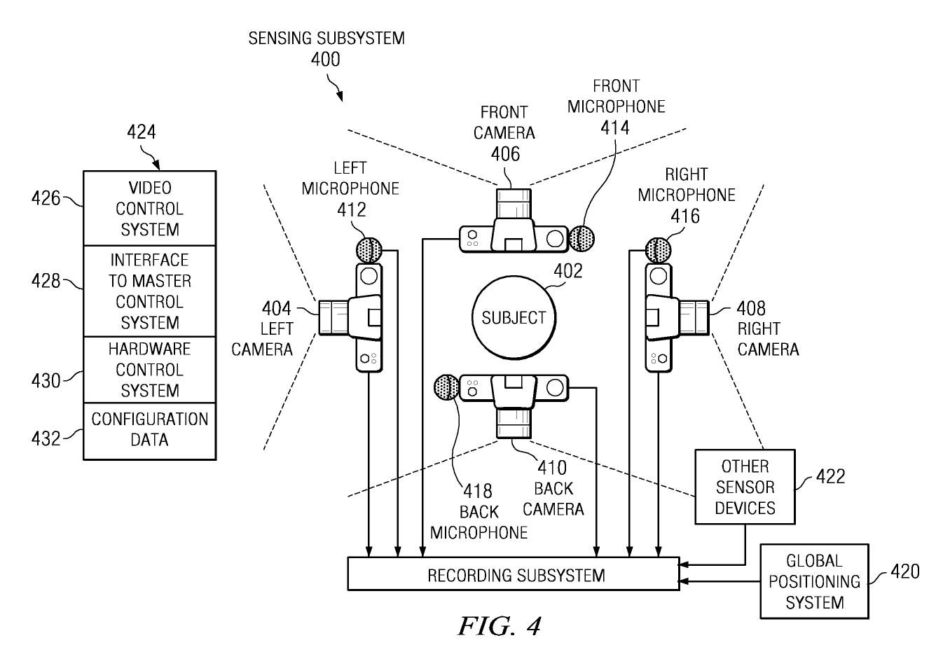

Sensing subsystem 302 also comprises of a computer for processing the data captured by the devices into a raw data queue. Further details of sensing subsystem 302 are described in FIG. 4 below.

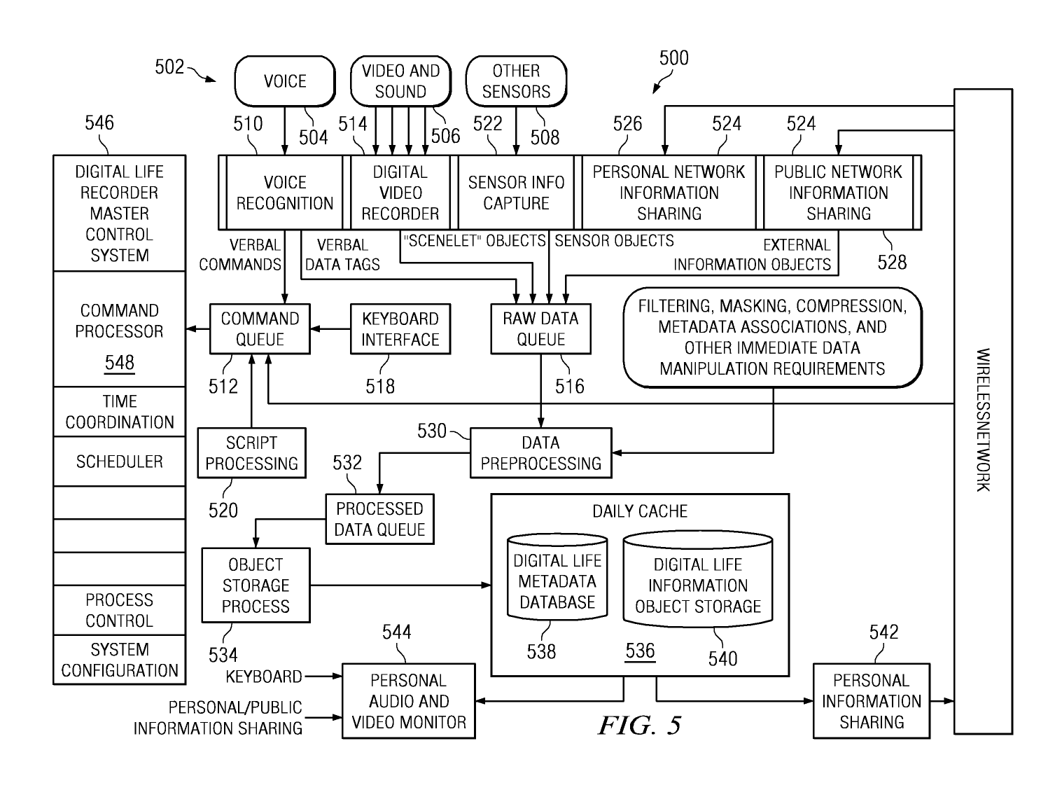

Sensing subsystem 302 transmits the raw data captured by the data capturing devices to digital life recording subsystem 304. Digital life recording subsystem 304 processes the raw data into a processed data queue and stores the data from the processed data queue into a daily cache of a mobile device associated with the person. The details of digital life recording subsystem 304 will be described in FIG. 5.

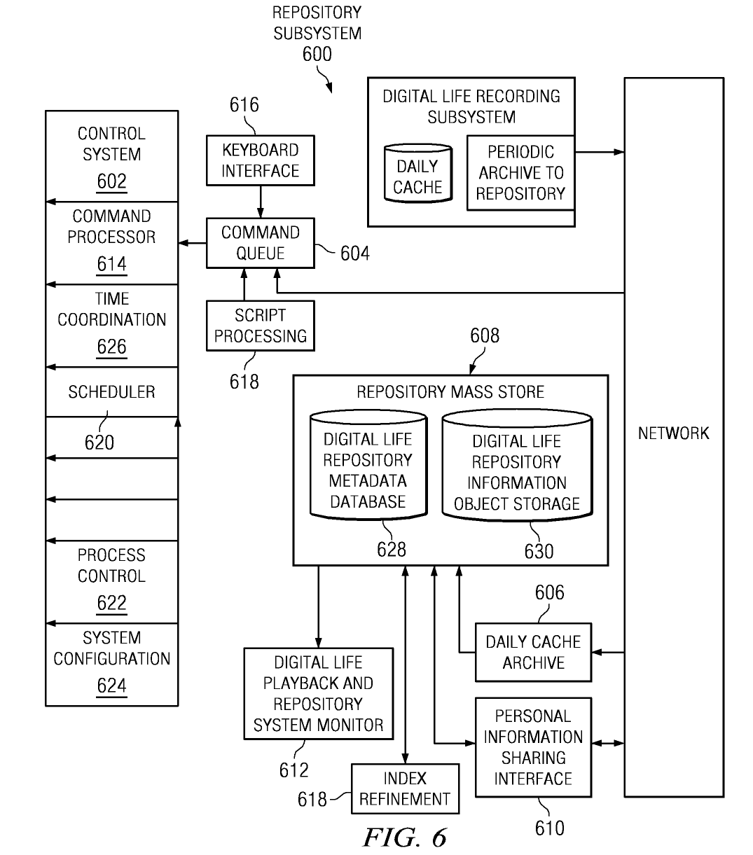

Digital life repository subsystem 306 manages the long-term storage and cataloging of the information representing the person's “digital life” that accumulates over time. On a periodic basis, digital life repository subsystem 306 interfaces with digital life recording subsystem 304 and uploads data stored in the cache of the mobile device. Additionally, details of digital life repository subsystem 306 will be described in FIG. 6.

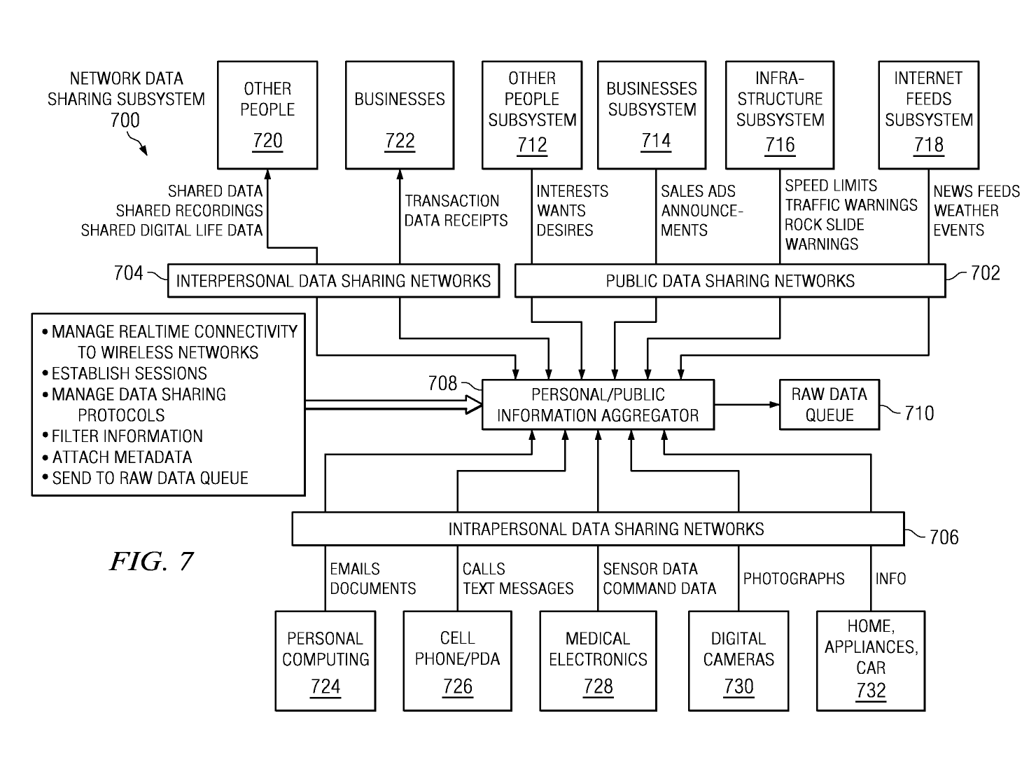

Network data sharing 308 is a component of digital life recording system 300. Network data sharing 308 provides functions, such as aggregating, organizing, formats, and attaching metadata to data acquired via public, inter-personal, and intra-personal data sharing networks. The resultant aggregate is fed into digital life recording subsystem 304 in these examples. Network data sharing 308 is further described in FIG. 7 below.

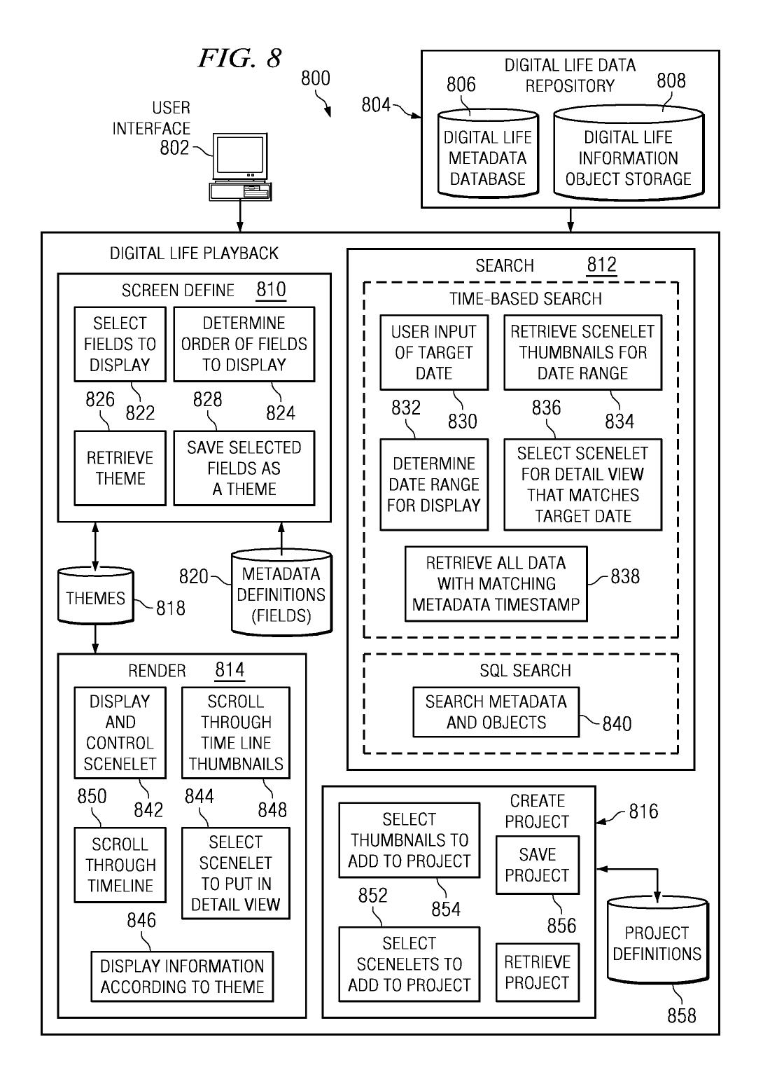

Digital life playback subsystem 310 is responsible for the user interface that organizes and presents the information, stored in the digital life repository subsystem 306, to a user for review and further processing. Additional details of digital life playback subsystem 310 will be described in FIG. 8.

With reference now to FIG. 4, a diagram of components in a sensing subsystem is depicted in accordance with an illustrative embodiment. Sensing subsystem 400 comprises of a plurality of data capturing devices associated with a person 402.

In this illustrative example, the data capturing devices comprises of a left camera 404, a front camera 406, a right camera 408, and a back camera 410. Additionally, a left microphone 412, a front microphone 414, a right microphone 416, and back microphone 418 are used for capturing audio data. A global positioning system 420 and other sensor devices 422 may also be associated with person 402. Other sensor devices 422 may include, but are not limited to, a set of biometric devices and a set of environmental sensor devices.

Data model 424 depicts the software components associated with managing sensing subsystem 400. Data model 424 comprises of a video control system 426, an interface to master control system 428, a hardware control system 430, and configuration data 432. The data captured by the data capturing devices is transmitted to a recording subsystem, as will be described below in FIG. 5.

FIG. 5 is a block diagram illustrating the data flow between components of a sensing subsystem and the components of a recording subsystem in accordance with an illustrative embodiment. The components of recording subsystem 500 may be implemented in a data processing system, such as data processing system 200 as shown in FIG. 2.

Recording subsystem 500 processes inputs and commands from all the different sources and stores the data in a daily cache. In this illustrative example, recording subsystem 500 comprises of a voice recognition component 510, a command queue 512, a digital video recorder 514, a raw data queue 516, a keyboard interface 518, a script processing 520, a sensor information capture 522, a data preprocessing component 530, a processed data queue 532, an object storage process 534, and a daily cache 536.

Recording subsystem 500 receives input from sensing subsystem 502. Sensing subsystem 502 depicts inputs received from data capturing devices in accordance with an illustrative embodiment of a sensing subsystem, such as sensing subsystem 302 in FIG. 3. Sensing subsystem 502 is responsible for capturing video and sound, voice commands, time and location, environmental details like temperature, biometric information, and any other information that can be imagined to be useful and for which sensors exist. In this example, inputs captured by sensing subsystem 502 includes voice input 504, video and sound input 506, and input from other sensors 508.

Digital life recorder master control system 546 directs the control of sensing subsystem 502. Master control system 546 passes the captured data on to recording subsystem 500 for further processing.

Recording subsystem 500 sends data received from voice input 504 to voice recognition component 510. Voice recognition component 510 processes the data received from voice input 504 to interpret voice commands. The voice commands are forwarded to command queue 512. Command queue 512 may also receive other types of input, such as, but not limited to, input from a cellular phone (not depicted), keyboard interface 518, or inputs received from script processing 520. A script is a set of commands written in an interpreted language to automate certain application tasks. Command queue 512 sends commands to master control system 546. These commands are executed by a command processor 548. The commands can be used to get feedback through headphones and/or display and allows the user to control and configure the system in near real-time.

Recording subsystem 500 passes data from video and sound input 506 to digital video recorder 514. Digital video recorder 514 converts analog data to digital data and organizes the data into data segments. Digital video recorder 514 also takes in metadata from the data capturing devices. Metadata is data that describes the content, quality, condition, origin, and other characteristics of data. The metadata includes a timestamp and location captured by a global positioning system device, such as global positioning system 420 shown in FIG. 4.

The data segments are tagged with the timestamp and location of when and where each data segment was captured prior to sending the data segments to raw data queue 516. In addition, data is captured from other sensors 508 and processed by sensor information capture 522 prior to relaying the data to raw data queue 516.

Additionally, raw data queue 516 includes external information data gathered from a network data sharing component 524. Network data sharing component 524 aggregates, organizes, formats, and attaches metadata to data acquired via public, inter-personal, and intra-personal data sharing networks. Network data sharing component 524 includes a personal network information sharing component 526 and a public network information sharing component 528. Network data sharing component 524 is described in more detail in FIG. 7 below.

Data preprocessing component 530 filters, masks, compresses, applies metadata associations, and processes other immediate data manipulation functions. Data preprocessing component 530 reads information from raw data queue 516 and passes the pre-processed data along to processed data queue 532. Recording subsystem 500 uses processed data queue 532 to temporarily store the data before passing the data along to the object storage process 534. Object storage process 534 places the data into daily cache 536. The data is placed into two separate databases within daily cache 536; digital life metadata database 538 and digital life information object database 540. Daily cache 536 has enough storage capacity to hold the captured data until recording subsystem 500 interfaces with a repository mass store.

Recording subsystem 500 uses a personal information sharing subsystem 542, as will be further described in FIG. 7, to broadcast information from digital life metadata database 538 and digital life information object database 540, within daily cache 536, to authorized users via a wireless or Bluetooth network. Recording subsystem 500 also uses a personal audio and video monitor subsystem 544 to provide a user interface to the data in daily cache 536. Recording subsystem 500 provides a keyboard, which can be used to enter commands and access the user interface functions. Recording subsystem 500 also provides a method to describe and connect to network data sharing component 524.

With reference now to FIG. 6, a block diagram illustrating the relationship between a recording subsystem and the components of a repository subsystem is depicted in accordance with an illustrative embodiment. The recording subsystem may be, for example, recording subsystem 500 shown in FIG. 5. The components of repository subsystem 600 illustrated in FIG. 6 may be implemented in a data processing system, such as data processing system 200 as shown in FIG. 2.

Repository subsystem 600 includes a control system 602, a command queue 604, a network interface (not depicted), a relational storage means called the repository (repository database 608), personal information sharing interface 610, and an interface to the playback subsystem (digital life playback and repository system monitor 612).

Control system 602 contains a command processor 614, which interprets and executes commands generated by either a keyboard interface 616, remote operation via the network, or scripts, which are executed (script processing 618) according to a scheduler 620. In addition, control system 602 manages, processes and threads (process control 622, system configuration 624, and any time coordination 626 that might be required.

Recording subsystem 500, as shown in FIG. 5, interfaces with a network, such as network 102 shown in FIG. 1, to upload data stored in the daily cache to repository subsystem 600. Repository subsystem 600 interfaces to the network to download the daily cache archive 606 previously stored by the recording subsystem.

Repository subsystem 600 stores the data into repository database 608. Repository database 608 includes two databases, digital life repository metadata database 628, and digital life repository information object storage 630, for long term storage and use. Digital life repository information object storage 630 stores the captured life data objects. Digital life repository metadata database 628 stores metadata used to index and describe the actual captured information objects that the digital life recording subsystem acquires during the life recording process. Additionally, repository database 608 may include information obtained through personal information sharing interface 610. Additional details of the network data sharing subsystem are described in more detail in FIG. 7 below.

On an ongoing basis, the indexing information in digital life repository metadata database 628 may be enhanced and refined by processes that study the captured data in the repository and update the index information (ongoing data and index refinement 629). An example of the refinement process includes analyzing audio data within an object to recognize words associated with the captured object. These words are then used as part of a full text search capability where the identified words are used as index information that points to the data objects that contains those words.

An interface, such as digital life playback and repository system monitor 612, exists between repository subsystem 600 and a playback subsystem. Digital life playback and repository system monitor 612 allows the playback subsystem to access the data existing in repository database 608 based on various searching techniques. The playback subsystem manages displaying of the data to a user. Digital life playback and repository system monitor 612 also manages the status and manipulation of the repository subsystem 600. Additional details of a playback subsystem are described in more detail in FIG. 8 below.

With reference now to FIG. 7, a block diagram illustrating the relationship between components of a network data sharing subsystem is depicted in accordance with an illustrative embodiment. The components of network data sharing subsystem 700 illustrated in FIG. 7 may be implemented in a data processing system, such as data processing system 200 as shown in FIG. 2.

Network data sharing subsystem 700 includes public data sharing network 702, interpersonal data sharing network 704, intrapersonal data sharing network 706, and a personal/public information aggregator 708.

Public data sharing network 702 provides connectivity to information that is being locally broadcast as well as predefined Internet feeds. The system may be composed of wireless networks configured to connect automatically when detected. Hard networks may also be used to capture additional information.

Additionally, public data sharing network 702 captures nearby information, from other people broadcasting information about themselves, via the other people subsystem 712. This information might be information about their interests and desires. Public data sharing network 702 also captures business information from nearby business broadcasts, such as, but not limited to, sales and advertisements via the businesses subsystem 714.

Additionally, public data sharing network 702 captures public and private infrastructure broadcasts via the infrastructure subsystem 716. The public and private infrastructure information may include, but are not limited to, speed limits, traffic conditions/warnings, and weather condition warnings. Public data sharing network 702 supports any network connectivity that allows Internet access via the Internet Feeds subsystem 718. Internet Feeds subsystem 718 is used to receive web based information, such as, but not limited to, news, weather, entertainment, and sports results.

Interpersonal data sharing network 704 is more specific to the person being monitored than is public data sharing network 702. Interpersonal data sharing network 704 does not receive broadcasts. Instead, interpersonal data sharing network 704 negotiates connections with other people 720 and businesses 722 to receive transaction oriented information for recording. For example, transaction information associated with transactions that occur between businesses and the person are recorded. The transaction information may include information about purchases, such as, but not limited to, price, model numbers, serial numbers, warranties, and receipts. Information shared from other people's digital life recording system is captured using a subsystem, such as other people 720.

Intrapersonal data sharing network 706 aggregates personal information about the person's life for recording. The personal information may be aggregated from a plurality of sources including, but not limited to, personal computing 724, cell phone/personal digital assistants (PDA) 726, medical electronics 728, digital cameras 730, and home appliances/car 732. The information captured from personal computing 724 may include, but is not limited to, emails, computer files, and computer-based communications like instant messages or voice over IP (VoIP). Bluetooth or other wireless/wired connectivity may be used for interfacing the data to the digital life recorder.

Intrapersonal data sharing network 706 may also capture cell phone conversations and PDA usage from cell phone/PDA 726 using Bluetooth connectivity or other transmission means. Additionally, intrapersonal data sharing network 706 may record the command and data associated with medical electronics 728. Images may also be captured from digital cameras 730. Digital cameras 730 include cameras that are not already associated with the sensing subsystem. Other data may include information associated with home appliances/car 732.

Personal/public information aggregator 708 aggregates, organizes, formats, and attaches metadata to data acquired via public data sharing network 702, interpersonal data sharing network 704, and intrapersonal data sharing network 706. The resultant aggregate is fed into the raw data queue 710 of a recording subsystem, such as recording subsystem 500 in FIG. 5.

Turning now to FIG. 8, a block diagram illustrating the components of a playback subsystem is depicted in accordance with an illustrative embodiment. The components of playback subsystem 800 illustrated in FIG. 8 may be implemented in a data processing system, such as data processing system 200 as shown in FIG. 2.

In this example, playback subsystem 800 comprises of several subsystems, such as, but not limited to, screen define subsystem 810, search subsystem 812, render subsystem 814, and create project subsystem 816. Additionally, playback subsystem 800 includes a user interface 802 associated with the digital life recording system. User interface 802 may be used to organize and present information stored in a data repository, such as repository database 608 shown in FIG. 6. Playback subsystem 800 interfaces with digital life data repository 804. Digital life data repository 804 includes digital life metadata database 806 and digital life information object storage database 808. Digital life data repository 804 may be similarly implemented as repository database 608 shown in FIG. 6.

Screen define subsystem 810 provides an interface to receive user inputs, such as, but not limited to, selecting the type of information a user wants to view. The type of information may include, but is not limited to, video information, sound information, temperature sensor information, or any of the other information captured by the recording system or network data sharing system. The definition for these types of information and their mapping to the digital life data database is managed through the metadata definitions database 820. The information can be organized on user interface 802 and then saved in a themes database 818 using the function save selected fields as a theme (block 828). Saved themes may be retrieved from themes database 818 using the retrieve theme (block 826) functionality. Other functionality provided by screen define subsystem 810 may include, but is not limited to, computer usable program code that allows a user to select fields to display (block 822), and to determine order of fields to display (block 824).

Search subsystem 812 allows a user to input a date/time range to select the data that the user wants to view (block 830). Search subsystem 812 determines the initial date range to display on the user interface (block 832) prior to searching digital life data repository 804. Search subsystem 812 retrieves the scenelet thumbnails from digital life information object storage database 808 for the time slices within the date range (block 834). A scenelet is a snippet of a scene. Additional details about a selected scenelet may be viewed (block 836).

For all non-video information or metadata that is to be displayed on the screen, such as, but not limited to, sound and temperature, similar searching is performed and summaries retrieved for each time slice (block 838). Detailed information for the requested date/time will also be retrieved. Similarly, a generic searching capability is provided that uses standard search language queries, such as Structured Query Language (SQL), to allow access to any aspect of the digital life data repository 804 (block 840).

Render subsystem 814 is used to render the information retrieved, using search subsystem 812, on user interface 802. As stated above, the layout of user interface 802 is defined using screen define subsystem 810 and stored in themes database 818. Render subsystem 814 provides functionality to display, manipulate, and control a scenelet (block 842), select a scenelet for a detail view (block 844), display information according to theme (block 846), scroll through time line of thumbnails (block 848), and scroll through time line (block 850).

Create project subsystem 816 is used to support the creation of a saved set of information found in digital life data repository 804. A user may, using user interface 802, select either scenelets (block 852) or thumbnails (block 854), from the render subsystem 814 and save the group of items as a project (block 856) in a project definitions database 858. Additionally, previously saved projects may be retrieved from the project definitions database 858 using user interface 802.

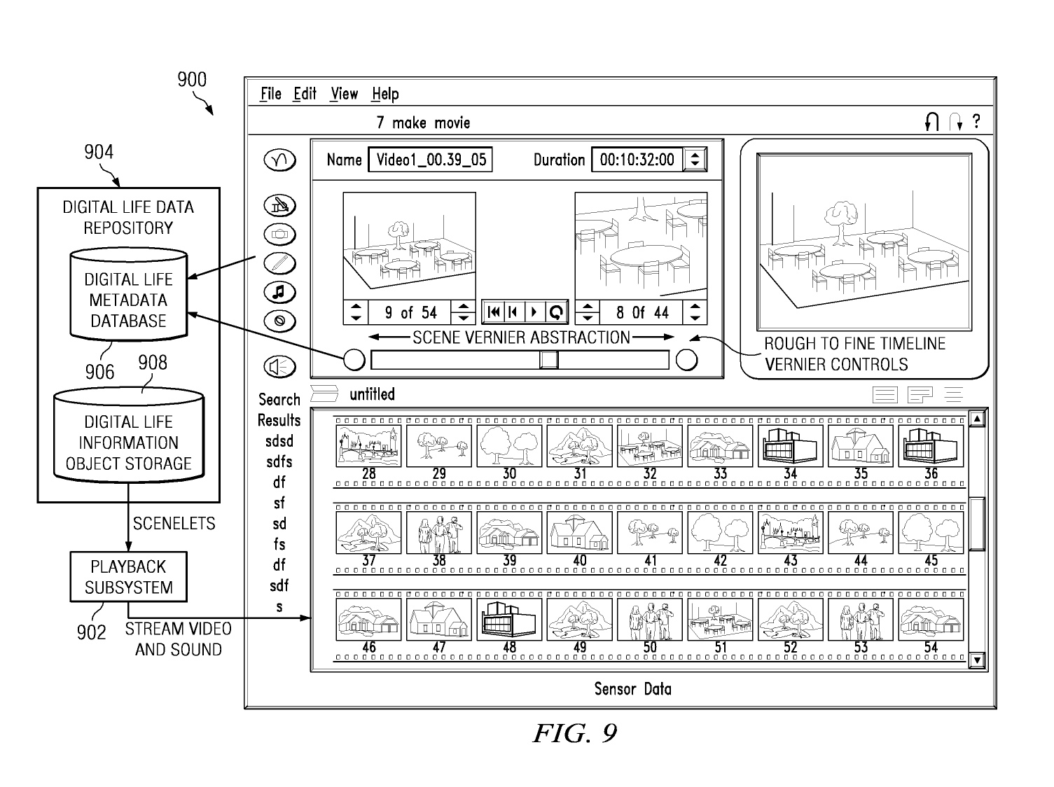

With reference now to FIG. 9, a user interface associated with a playback subsystem is depicted in accordance with an illustrative embodiment. Playback subsystem 902 uses data acquired from a digital life data repository 904. Digital life data repository 904 contains digital life metadata database 906 and digital life information object storage database 908. Digital life data repository 904 may be similarly implemented as repository database 608 shown in FIG. 6.

The results associated with a search are depicted on the left hand side of user interface 900. Additionally, user interface 900 provides a mechanism for adjusting the timeline vernier. The timeline vernier controls the precision of time. Thus, a user can adjust from a rough timeline vernier to a more precise/fine timeline vernier. Scenelets associated with a selected result is presented in the bottom half of user interface 900.

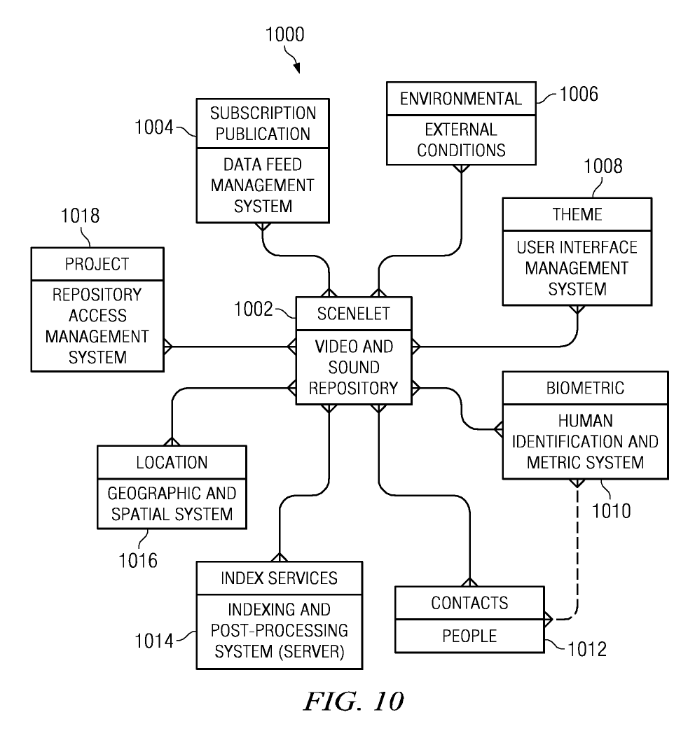

FIG. 10 is a diagram of a data model in accordance with an illustrative embodiment. Digital life conceptual data model 1000 may include, but is not limited to, the following subsystems: scenelet 1002, subscription/publication 1004, environmental 1006, theme 1008, biometric 1010, contacts 1012, index services 1014, location 1016, and project 1018.

Scenelet 1002 organizes and manages the image and sound files. Subscription/publication 1004 manages the external data feeds into and out of the digital life system, such as digital life recording system 300 shown in FIG. 3. Environmental 1006 captures and manages environmental characteristics related to the scenelet data. Theme 1008 allows users to customize and manage their digital life system interfaces and experiences. Biometric 1010 captures and manages biometric information associated with human contacts within the scenelets. Contacts 1012 is a repository of known contacts. Index services 1014 provides post processing capability to further analyze and categorize scenelet data. Location 1016 captures and manages specific location related details during a scenelet. Project 1018 provides an access management system that allows users to customize data retrieval.

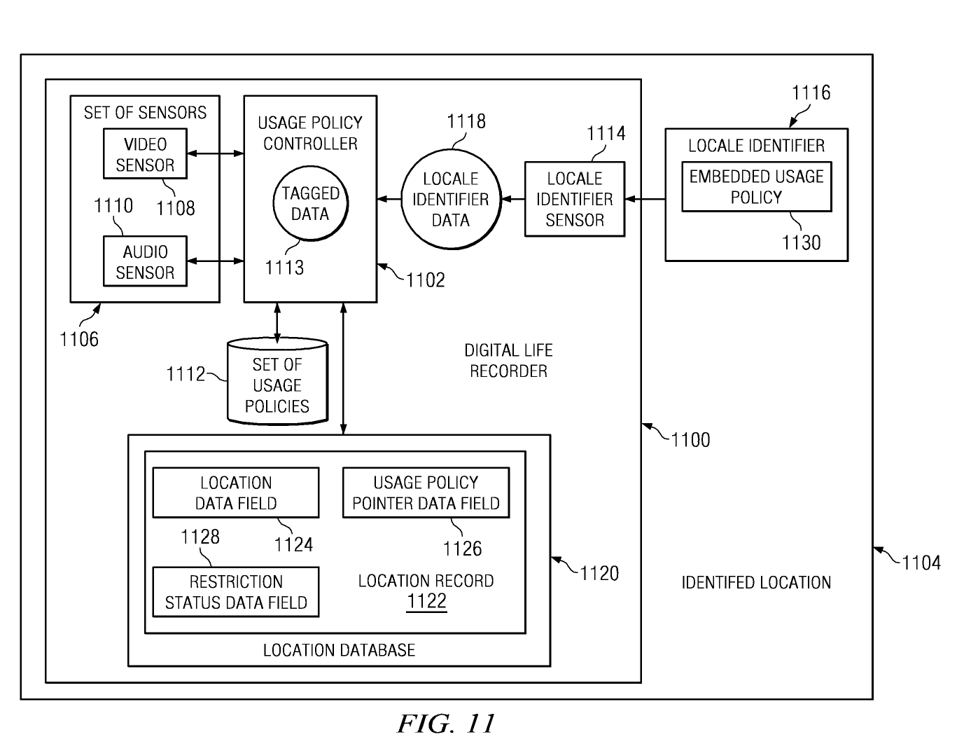

FIG. 11 is a block diagram showing the operation of a digital life recorder in an identified location in accordance with an illustrative embodiment. Digital life recorder 1100 is a digital life recorder, such as the digital life recorder in digital life recording system 300 in FIG. 3.

Digital life recorder 1100 includes usage policy controller 1102. Usage policy controller 1102 is a software component for controlling the capture of data at identified location 1104. Identified location 1104 is any location in which a user of digital life recorder 1100 may be present. Identified location 1104 may be, for example, an indoor or outdoor music venue, a building, a room within a building, an underground parking garage, an interior of a vehicle, or any other location.

Usage policy controller 1102 controls the capture of data at identified location 1104 by disabling and/or enabling the operation of set of sensors 1106 based upon a location of digital life recorder 1100. Set of sensors 1106 are sensors of a sensing subsystem of digital life recorder 1100. Set of sensors 1106 includes audio sensors 1110 and video sensors 1108. Audio sensors 1110 is a set of one or more sensors, such as microphones 412, 414, 416, and 418 in FIG. 4. Audio sensors 1110 detects and records sounds and other forms of audio-based information. Video sensors 1108 is a set of one or more sensors, such as cameras 404, 406, 408, and 410 in FIG. 4. Video sensors 1108 detects and records images and other visual-based information. Thus, usage policy controller controls the capture of data at identified location 1104 by disabling and/or enabling at least one of audio sensor 1110 and video sensors 1108. In other words, usage policy controller may disable either audio sensors 1110, video sensors 1108, or both.

Usage policy controller 1102 controls set of sensors 1106 with reference to set of usage policies 1112. Set of usage policies 1112 is one or more rules that instruct usage policy controller 1102 whether and when set of sensors 1106 may collect data at identified location 1104. For example, set of usage policies 1112 may include a rule preventing the collection of any data in a selected room of a house for protecting the privacy of a user of digital life recorder 1100. Set of usage policies 1112 may also include a rule that prevents the collection of audio data at a concert. Another rule of set of usage policies 1112 may prevent the collection of video data at a studio in which photographs are taken. Other rules may be included within set of usage policies 1112 for specifying locations in which data may be collected and the types of data that may be collected.

In an alternate embodiment, set of usage policies 1112 may instruct usage policy controller 1102 to tag a data feed collected at identified location 1104 for restricted playback to form tagged data 1113. Tagged data 1113 is data collected at identified location 1104 tagged with one or more recording restrictions specified by set of usage policies 1112. Tagged data 1113 may include audio data and video data. In this embodiment, the capture of data at identified location 1104 is not restricted. On the contrary, all data may be captured at identified location 1104. However, rules set forth in set of usage policies 1112 may prohibit playback of certain aspects of tagged data 1113. For example, set of usage policies 1104 may allow playback of audio data captured at identified location 1104 but may prohibit playback of video data captured at identified location 1104. Thus, as set of sensors 1106 captures data at identified location 1104, usage policy controller 1102 may tag the video data collected at identified location 1104 form tagged data 1113. When a playback subsystem encounters tagged data 1113, the playback subsystem prevents a presentation of the video data collected at identified location 1104. Tagged data may be selectively replayed if the requisite authority is obtained. In one example, authority may be obtained from the owner of identified location 1104, or from a court of law.

Usage policy controller 1102 controls the capture of data at identified location 1104 based upon a type or identity of identified location 1104. Usage policy controller 1102 utilizes locale identifier sensor for determining a type or identity of a location in which digital life recorder 1100 is present to form identified location 1104. Locale identifier sensor 1114 is a sensing device configured to detect locale identifier 1116. Locale identifier 1116 is an identifier usable to distinguish a location in which locale identifier 1116 is located. For example, locale identifier 1116 may be a bar code, a radio frequency identification tag, a device emitting a specific audio frequency, a light source emitting a particular wavelength of light, or any other object or device included in identified location 1104.

Thus, where locale identifier 1116 is a bar code, locale identifier sensor 1114 is a bar code scanner that detects and reads locale identifier 1116. Similarly, locale identifier 1116 may be a radio frequency identification tag and locale identifier sensor 1114 may be a radio frequency identification tag reader. Locale identifier sensor 1114 may detect the presence of locale identifier 1116 when digital life recorder 1100 enters identified location 1104. In other embodiments, locale identifier 1116 may also be a unique wall color of a location, a selected arrangement of objects in a location, an odor of a location, or any other characteristic of a location that may be detected by locale identifier sensor 1114. In these embodiments, locale identifier sensor 1114 is a sensing device capable of detecting locale identifier 1116.

Locale identifier sensor 1114 detects the presence of locale identifier 1116 and generates locale identifier data 1118 for use by usage policy controller 1102 for controlling the capture of data at identified location 1104. Locale identifier data 1118 is data describing or otherwise associated with the type or identity of identified location 1104. Locale identifier data 1118 is data derived from locale identifier 1116. For example, if identified location 1104 is a kitchen, then locale identifier data 1118 may notify usage policy controller 1102 that identified location 1104 is a generic kitchen. In another embodiment, usage policy controller 1102 may identify a particular location using locale identifier data 1118. In this embodiment, locale identifier data 1118 may be an alphanumeric string of text identifying a particular kitchen. Thus, usage policy controller 1102 may identify a particular kitchen in a location having multiple kitchens, such as in a resort hotel. By using locale identifier data 1118, usage policy controller 1102 may control the operation of set of sensors 1106 by a generic location type, or by a unique set of restrictions governing a specific location.

In the absence of locale identifier 1116, locale identifier sensor 1114 may generate locale identifier data 1118 to inform usage policy controller 1102 that a location of digital life recorder 1100 is not an identified location. In one embodiment, unidentified locations are not subject to recording restrictions. Alternatively, unidentified locations may be subject to a generic or default locale restriction from set of usage policies 1112.

Data used by usage policy controller 1102 for controlling the capture of data at identified location 1104 is stored in location database 1120. Location database 1120 is a data structure, such as, for example, a relational database, a table, an array, or other form of data structure. The data stored in location database 1120 is maintained in location records, such as location record 1122. Location record 1122 is an entry of location database 1120 corresponding to identified location 1104. Location record 1122 may be generic and apply to more than one identified location. Alternatively, location record 1122 may apply to only a specific location. For example, location record 1122 may apply to all concert halls, or location record 1122 may apply to a selected concert hall.

Location record 1122 is an entry in location database 1120 corresponding to identified location 1104. Location record 1122 includes location data field 1124. Location data field 1124 is a data field of location record 1122 that corresponds to identified location 1104. Location data field 1124 may serve as a primary key differentiating location records from one another. In one embodiment, location data field 1124 stores a type of location or a unique identifier associated with a particular location. For example, location data field 1124 may include a word corresponding to the type of location to which location record 1122 applies. Thus, location data field 1124 may include words, such as “kitchen,” “garage,” “concert hall,” “pool,” or any other location type. Alternatively, location data field 1124 may store an alphanumeric identifier corresponding to a particular location. For example, the alphanumeric identifier may specify that location record 1122 applies to a particular pool at a hotel or a specific parking garage at a mall.

Location record 1122 may include usage policy pointer data field 1126. Usage policy pointer data field 1126 is a data field storing a pointer identifying recording restrictions from a set of usage policies that apply to identified location 1104. Usage policy controller 1102 may reference pointers stored in usage policy pointer data field 1126 to locate the recording restrictions governing the capture of data at identified location 1104.

Location record 1122 may also include restriction status data field 1128. Restriction status data field 1128 is a data field storing information pertaining to recording restrictions of identified location 1104, which are active, inactive, or temporarily disabled. For example, restriction status data field 1128 may include information indicating that audio recording at identified location 1104 is prohibited, but that video recording is permitted. Usage policy controller 1102 may populate this field with information in the first instance that digital life recorder 1100 enters identified location 1104. In addition, usage policy controller 1102 may update this field as recording restrictions are updated. Usage policy controller 1102 may then reference information stored in restriction status data field 1128 for controlling the capture of data at identified location 1104 in the event that locale identifier 1116 is undetectable. For example, if a user of digital life recorder 1100 is in identified location 1104 and locale identifier 1116 is a bar code in identified location 1104 that has been obstructed, then usage policy controller 1102 may continue to control data collection at identified location 1104 using the data stored in restriction status data field 1128.

In another embodiment, usage policy controller 1102 may control the capture of data from identified location 1104 using embedded usage policy 1130. Embedded usage policy 1130 is a usage policy specified by locale identifier 1116. Embedded usage policy 1130 specifies the provisions governing the collection of data at identified location 1104, or alternatively, the types of data for tagging and selective playback. The provisions of embedded usage policy 1130 may be passed to usage policy controller 1102 in locale identifier data 1118. Consider an example where locale identifier 1116 is a radio frequency identification tag and locale identifier sensor 1114 is a radio frequency identification tag reader. Locale identifier 1116 is encoded with information that forms embedded usage policy 1130. When locale identifier 1116 receives a radio frequency signal from locale identifier sensor 1114, locale identifier 1116 returns embedded usage policy 1130 to locale identifier sensor 1114. Locale identifier sensor 1114 may transmit the provisions of embedded usage policy 1130 to usage policy controller 1102 in locale identifier data 1118.

In an illustrative embodiment, a user operating digital life recorder 1100 enters a location. In the absence of locale identifier 1116, usage policy controller 1102 may allow unrestricted data capture. Alternatively, usage policy controller 1102 may invoke a default usage policy that may limit the capture of some data at the location.

If the user operating digital life recorder 1100 enters identified location 1104 having locale identifier 1116, then the capture of data by digital life recorder 1100 may be limited according to one or more usage policies. If locale identifier 1116 includes embedded usage policy 1130, then locale identifier sensor 1114 sends the provisions of embedded usage policy 1130 to usage policy controller 1102 in locale identifier data 1118. Usage policy controller 1102 then limits the capture of data at identified location 1104 according to the provisions of embedded usage policy 1130.

However, if locale identifier 1116 does not include embedded usage policy 1130, then usage policy controller 1102 searches set of usage policies 1112 for a usage policy applicable to identified location 1104. Usage policy controller 1102 may locate the applicable usage policy by first locating location record 1122. Location record 1122 includes usage policy pointer data field 1126 that identifies the usage policy from set of usage policies that applies to identified location 1104. Usage policy controller 1102 may locate location record 1122 by associating data included in locale identifier data 1118 with data stored in location data field 1126.

Usage policies governing the capture of data at identified location 1104 may restrict the capture of data or may instruct usage policy controller 1102 to tag certain types of data for selective playback. If usage policies applicable to identified location 1104 restrict the capture of data, then usage policy controller 1102 may disable audio sensor 1110 and/or video sensor 1108. If usage policies restrict playback of types of data, then set of sensors are allowed to capture data at identified location. Restricted data types are tagged by usage policy controller 1102 during or after collection. A playback system, such as digital life playback subsystem 310 in FIG. 3, may then present to a user any data that has not previously been tagged.

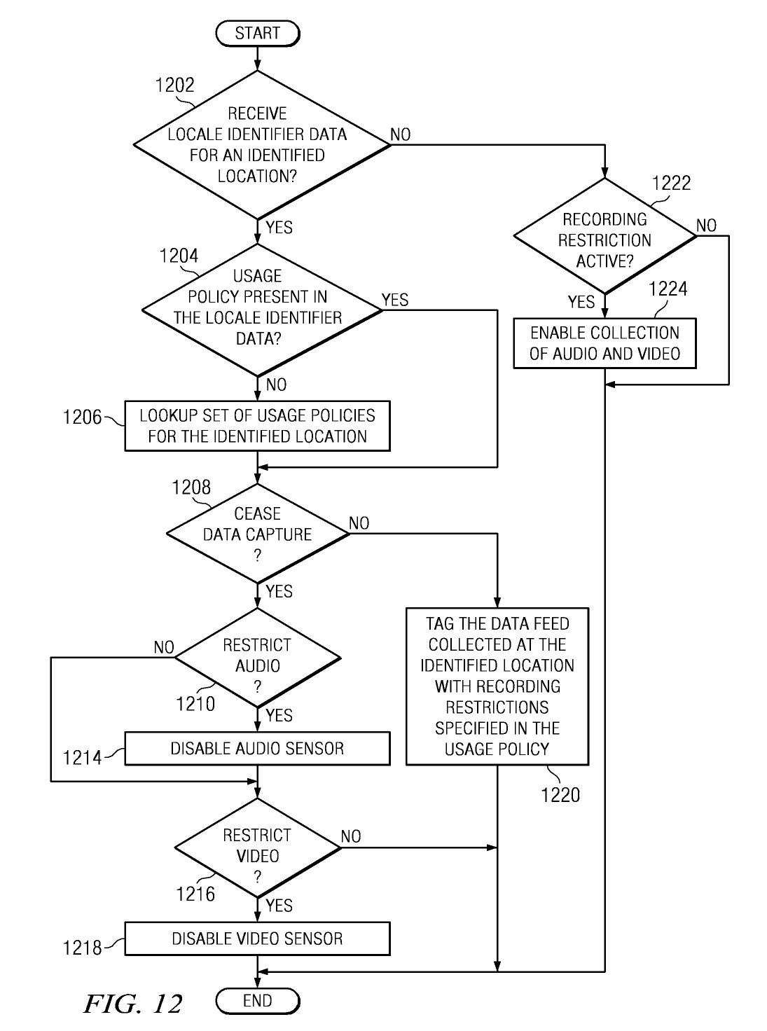

FIG. 12 is a flowchart of a process for controlling the operation of a digital life recorder in an identified location in accordance with an illustrative embodiment. The process of FIG. 12 may be may be implemented in a digital life recording system, such as digital life recording system 300 shown in FIG. 3. In particular, the process in FIG. 12 may be implemented by a usage policy controller, such as usage policy controller 1102 in FIG. 11.

The process begins by making the determination as to whether locale identifier data has been received for an identified location (step 1202). The locale identifier data may be received from a locale identifier sensor, such as locale identifier sensor 1114 in FIG. 11.

The process then makes the determination as to whether the usage policy is present in the locale identifier data (step 1204). If the process makes the determination that the usage policy is not present in the locale identifier data, then the process performs a lookup of the set of usage policies for the identified location (step 1206). The process then makes the determination as to whether the set of usage policies instructs the process to cease data capture (step 1208). If the process makes the determination that the set of usage policies instructs the process to cease data capture, then the process makes the determination as to whether the set of usage policies restrict the collection of audio (step 1210). If the set of usage policies restricts the collection of audio, then the process disables the audio sensor (step 1214). The process then makes the determination as to whether the set of usage policies restrict the collection of video (step 1216). If the process makes the determination that the set of usage policies requests restriction of video, then the process disables the video sensor (step 1218) and then the process terminates.

Returning now to step 1210, if the process makes the determination that a restriction of audio is not requested, then the process continues to step 1216. Similarly, if at step 1216, the process makes the determination that a restriction of video is required, then the process terminates.

With reference to step 1204, if the process makes the determination that a usage policy is present in the locale identifier data, then the process continues to step 1208.

At step 1208, if the process makes the determination that the set of usage policies does not request the process to cease collection of data, then the process tags the data feed collected at the identified location with recording restrictions specified in the usage policy (step 1220), and the process terminates.

With reference to step 1202, if the process makes the determination that location data is not received, then the process makes the determination as to whether a recording restriction is active (step 1222). If the process makes the determination that a recording restriction is not active, then the process terminates. However, if the process makes the determination that a recording restriction is active, in the absence receiving location data, then the process enables collection of audio and video (step 1224). The process terminates thereafter.

FIG. 13 is a flowchart of a process for capturing data of a locale identifier in accordance with an illustrative embodiment. The process of FIG. 13 may be may be implemented in a digital life recording system, such as digital life recording system 300 shown in FIG. 3. In particular, the process in FIG. 13 may be implemented in a locale identifier sensor, such as locale identifier sensor 1114 in FIG. 11.

The process begins by monitoring for a locale identifier (step 1302). The locale identifier is a locale identifier, such as locale identifier 1116 in FIG. 11. The process then makes the determination as to whether a locale identifier has been detected (step 1304).

If the process makes the determination that the locale identifier has not been detected, then the process informs the usage policy controller of an absence of the locale identifier (step 1306). The usage policy controller is a usage policy controller, such as usage policy controller 1102 in FIG. 11. Thereafter, the process returns to step 1302.

Returning now to step 1304, if the process makes the determination that a locale identifier is detected, then the process sends the locale identifier to the usage policy controller (step 1308) and the process terminates. In another embodiment, rather than terminating, the process in FIG. 13 may return to step 1302 in response to sending the locale identifier to the usage policy controller. In this manner, the process may continually monitor for a locale identifier for presenting to a usage policy controller up-to-date data for use in controlling the operation a set of sensors of a digital life recorder.

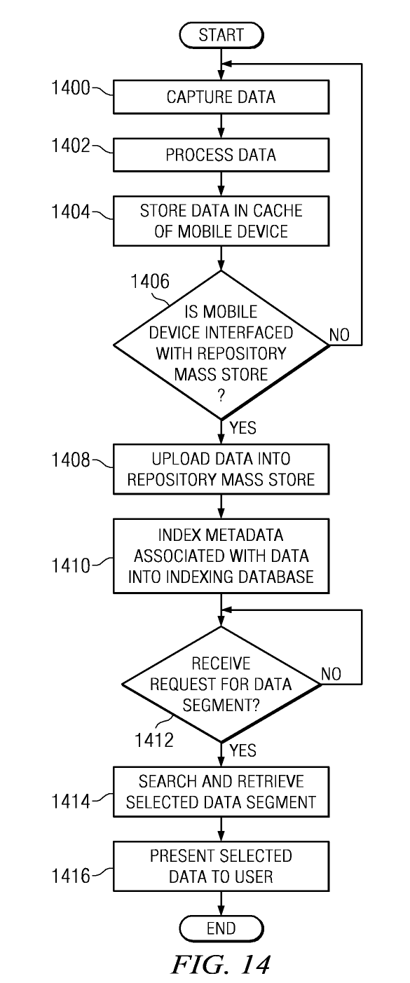

With reference now to FIG. 14, a high-level flowchart is presented illustrating a process for capturing, storing, and presenting data in accordance with an illustrative embodiment. The process illustrated in FIG. 14 may be implemented in a digital life recording system, such as digital life recording system 300 shown in FIG. 3.

The process begins by capturing data associated with daily activities of a person using data capturing devices (step 1400). The captured data is processed by a mobile device associated with the person (step 1402). The data is then stored in a cache of the mobile device (step 1404). The process monitors the mobile device to determine when the mobile device is interfaced with a repository mass store (step 1406). Interfacing may occur when the mobile device is in the vicinity of the repository mass store and connection is established via a wireless transmission link. Interfacing may also occur when the mobile device is docked to a repository mass store. The process continues the process of capturing (step 1400), processing (step 1402), and storing (step 1404) the data until a determination is made that the mobile device is interfaced with a repository mass store.

In response to interfacing the mobile device to a repository mass store, the process uploads the data stored in the cache of the mobile device into the repository mass store (step 1408). Metadata associated with the data, is indexed into an indexing database (step 1410). The process monitors for a request, from a user, to retrieve a selected data segment (step 1412). In response to receiving a request for a selected data segment, the process performs a search and retrieves the selected data segment from the repository mass store (step 1414). The process presents the selected data segment to the user (step 1416), with the process terminating thereafter.

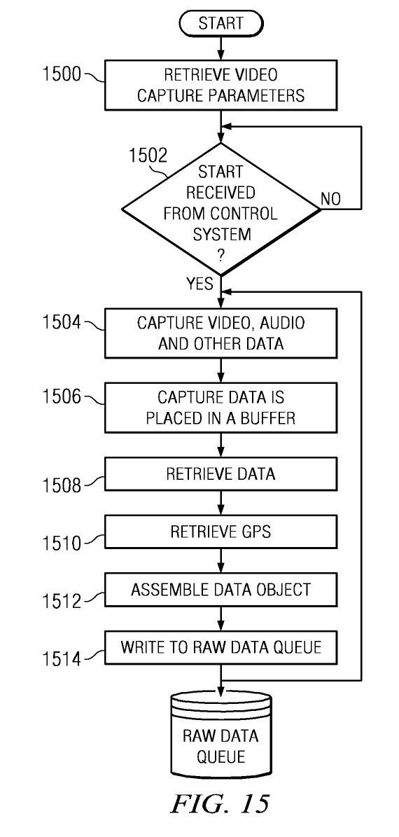

With reference now to FIG. 15, a flowchart illustrating a process for capturing life data is depicted in accordance with an illustrative embodiment. The process illustrated in FIG. 15 may be implemented in a digital life recording system, such as digital life recording system 300 shown in FIG. 3.

The process begins by retrieving the video capture parameters (step 1500). The process monitors for start request from the control system (step 1502). In response to receiving a start request from the control system, the process captures the video, audio, and other data from the data capturing devices associated with a person (step 1504). The captured data is placed in a buffer for temporary storage (step 1506). The process retrieves data from the buffer (step 1508). Additionally, the process retrieves data associated with a global positioning system device (step 1510). The process assembles a data object by associating the data associated with a global positioning system device with the data retrieved from the buffer (step 1512). The process writes the data object to a raw data queue (step 1514). The process repeats steps 1504-1514 until all the data in the buffer is written to the raw data queue.

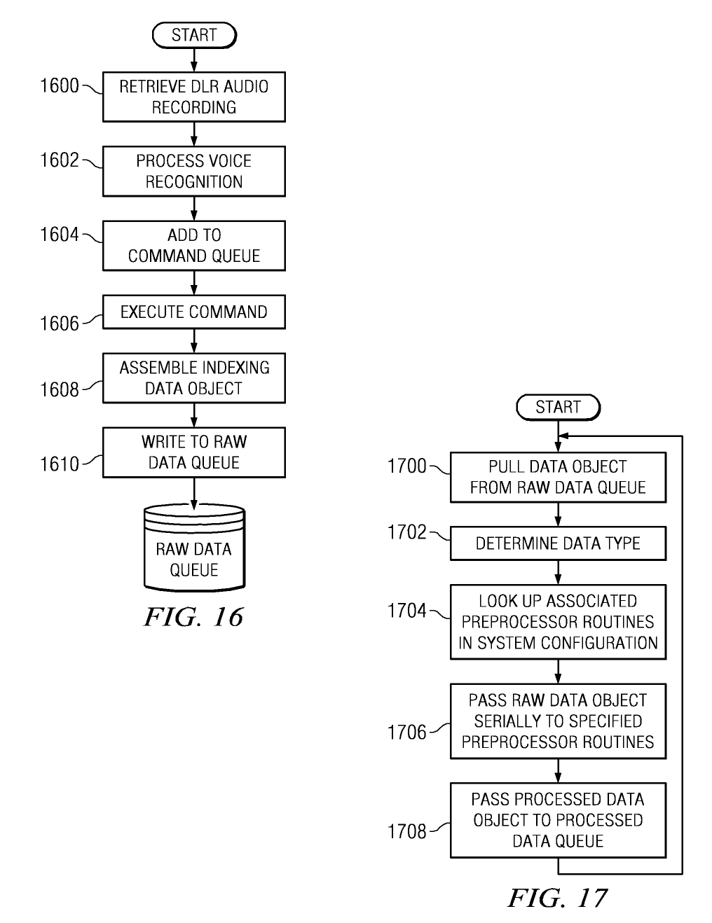

FIG. 16 is a flowchart of a process for improving the indexing of the stored data by tagging life data objects in accordance with an illustrative embodiment. The process illustrated in FIG. 16 may be implemented in a digital life recording system, such as digital life recording system 300 shown in FIG. 3.

The process begins by retrieving audio recording associated with a digital life recording system (step 1600). The audio recording is processed through a voice recognition subsystem to interpret voice commands (step 1602). The process adds the voice commands to a command queue (step 1604). Commands may also be added to the command queue using a mouse or keyboard. The tagging command includes a timestamp and a descriptive text index tag string. The process executes the commands stored in the command queue (step 1606). The process assembles the descriptive text index tag string and timestamp into an indexing data object (step 1608). The process writes the tagged data object to a raw data queue (step 1610) for later placement into the metadata database, with the process terminating thereafter.

FIG. 17 is a flowchart of a process for preprocessing raw recorded data in accordance with an illustrative embodiment. The process illustrated in FIG. 17 may be implemented in a digital life recording system, such as digital life recording system 300 shown in FIG. 3.

The process begins by pulling a data object from the raw data queue (step 1700). The process determines the data type of pulled data object (step 1702). The process looks up the associated preprocessor routines in system configuration (step 1704). The process passes the raw data object serially to the specified preprocessor routines (step 1706). The specified preprocessor routines return the processed data object to the process. The process then passes the processed data object to a processed data queue (step 1708). The process loops and repeats steps 1700-1708.

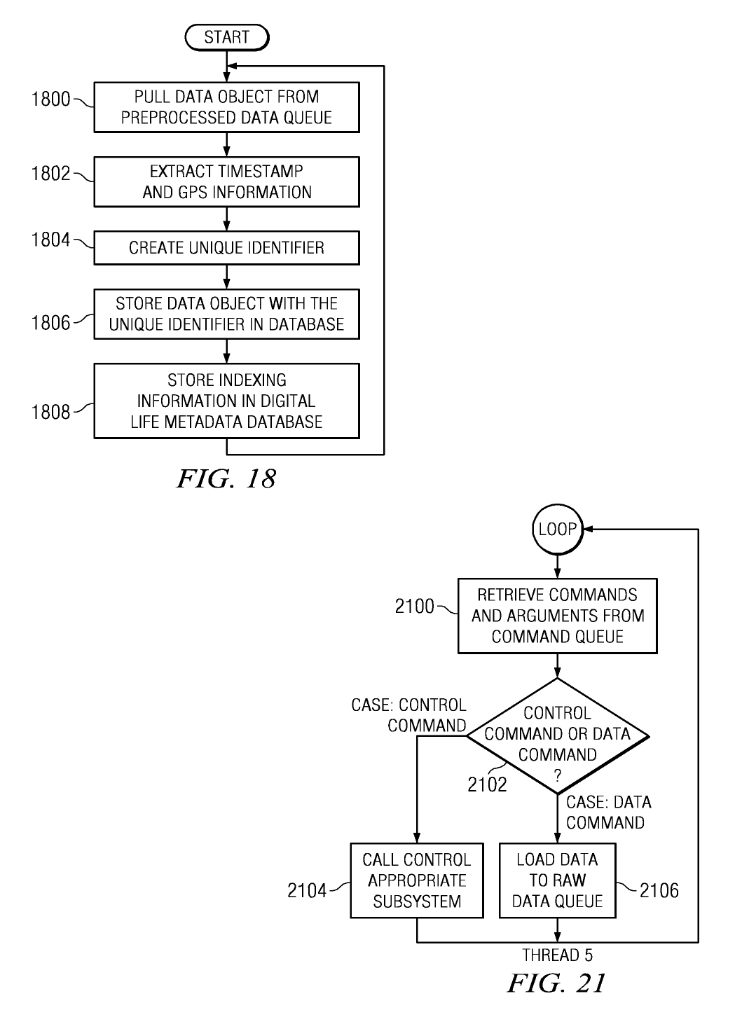

FIG. 18 is a flowchart of a process for creating a unique identifier for indexing and storing data objects in accordance with an illustrative embodiment. The process illustrated in FIG. 18 may be implemented in a digital life recording system, such as digital life recording system 300 shown in FIG. 3.

The process begins by pulling a data object from the preprocessed data queue (step 1800). The process extracts the timestamp and global positioning system (GPS) information from the data object (step 1802). The process creates a unique identifier for identifying the data object (step 1804). The process then stores the data object along with the unique identifier in a digital life information object storage database (step 1806), such as digital life repository information object storage 630 shown in FIG. 6. The process stores indexing information, such as, but not limited to, a timestamp, global positioning system information, the unique identifier, and the physical location of where the data object is stored in the digital life information object storage database, in a digital life repository metadata database (step 1808), such as digital life repository metadata database 628 shown in FIG. 6. The process loops and repeats steps 1800-1808.

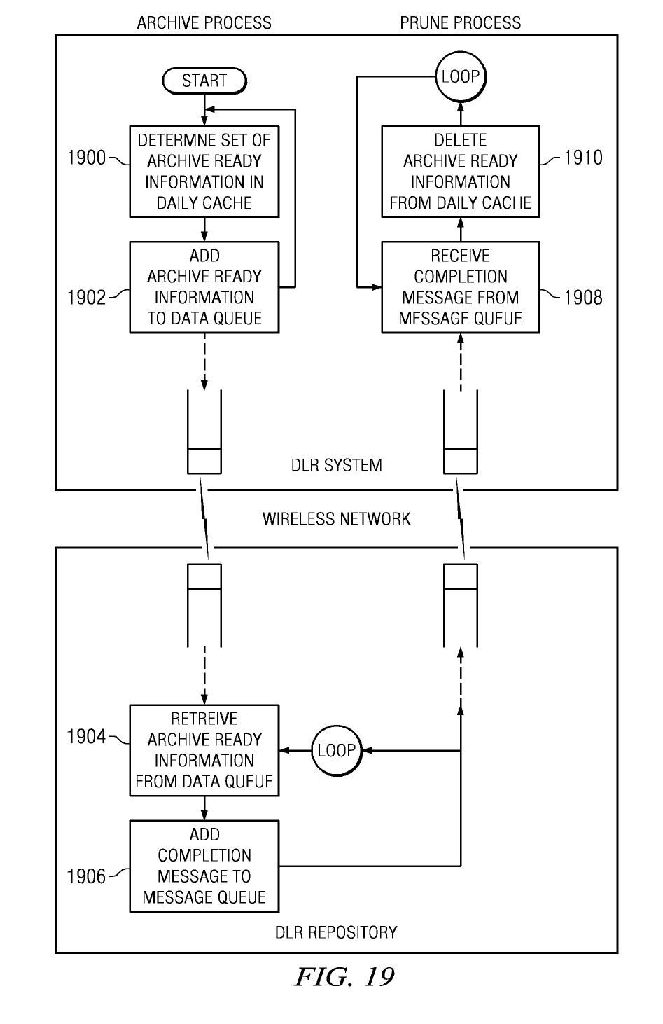

FIG. 19 is a flowchart of a process for archiving data objects in accordance with an illustrative embodiment. The process illustrated in FIG. 19 may be implemented in a digital life recording system, such as digital life recording system 300 shown in FIG. 3.

The process begins by determining a set of archive ready information stored in the daily cache of a mobile device (DLR system) (step 1900). The mobile device is associated with a person being recorded. The archive ready information comprises of the stored data objects, metadata, and other data associated with the captured data. The process adds the set of archive ready information to a data queue (step 1902). The process loops and repeats the steps of determining (step 1900) and adding (step 1902) archive ready information to a data queue until there is no more archive ready information.

In response to the mobile device interfacing with a repository mass store, the process retrieves the set of archive ready information from the data queue (step 1904). The process inserts the set of archive ready information into the repository mass store, such as repository database 608 shown in FIG. 6. The process then adds a completion message to a message queue (step 1906). The process loops and repeats the steps of retrieving (step 1904) and inserting (step 1906) archive ready information into the repository mass store until all archive ready information is stored in the repository mass store.

The process receives completion messages from the message queue (step 1908). In response to receiving the completion messages from the message queue, the process deletes the set of archive ready information from the daily cache (step 1910). The process loops and repeats the steps of receiving completion messages from the message queue (step 1908) and deleting the set of archive ready information from the daily cache (step 1910).

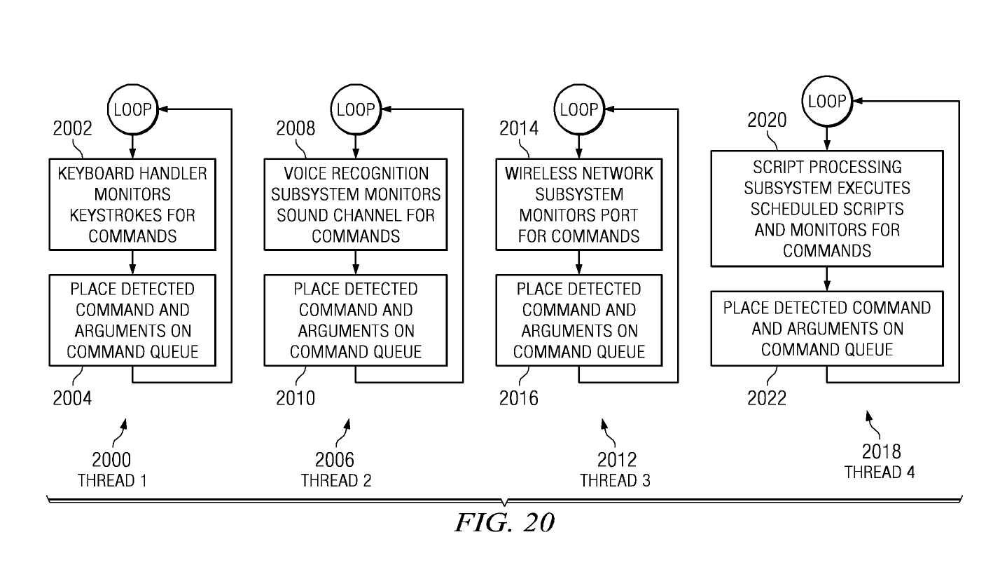

FIG. 20 is illustrates different processes for adding commands to a command queue in accordance with an illustrative embodiment. The processes illustrated in FIG. 20 may be implemented in a digital life recording system, such as digital life recording system 300 shown in FIG. 3.

In process 2000, a keyboard handler monitors keystrokes for commands (step 2002). In response to detecting a command, the detected command along with the associated arguments is placed on the command queue (step 2004). Process 2000 loops and continues monitoring (step 2002) and adding detected commands (step 2004) to the command queue.

In process 2006, a voice recognition subsystem monitors the sound channels for commands (step 2008). In response to detecting a command, the detected command along with the associated arguments is placed on the command queue (step 2010). Process 2006 loops and continues monitoring (step 2008) and adding detected commands (step 2010) to the command queue.

In process 2012, a wireless network subsystem monitors the ports for commands (step 2014). In response to detecting a command, the detected command along with the associated arguments is placed on the command queue (step 2016). Process 2012 loops and continues monitoring (step 2014) and adding detected commands (step 2016) to the command queue.

In process 2018, a script processing subsystem executes scheduled scripts and monitors for commands (step 2020). In response to detecting a command, the detected command along with the associated arguments is placed on the command queue (step 2022). Process 2018 loops and continues monitoring (step 2020) and adding detected commands (step 2022) to the command queue.

With reference to FIG. 21, a flowchart a process for processing commands is depicted in accordance with an illustrative embodiment. The process illustrated in FIG. 21 may be implemented in a digital life recording system, such as digital life recording system 300 shown in FIG. 3.

The process begins by retrieving commands and their associated arguments from a command queue (step 2100), such as command queue 512 shown in FIG. 5. The process interprets the retrieved command to determine if the retrieved command is a control command or a data command (step 2102). A control command is a command that modifies the operation of the digital life recording system. A data command is command request to select data associated with the digital life recording system.

In response to determining that the retrieved command is a control command, the process calls the control appropriate subsystem for processing the command (step 2104). In response to determining that the retrieved command is a data command, the process loads selected data to the raw data queue (step 2106). The process loops and repeats steps 2100-2106 for all commands in the command queue.

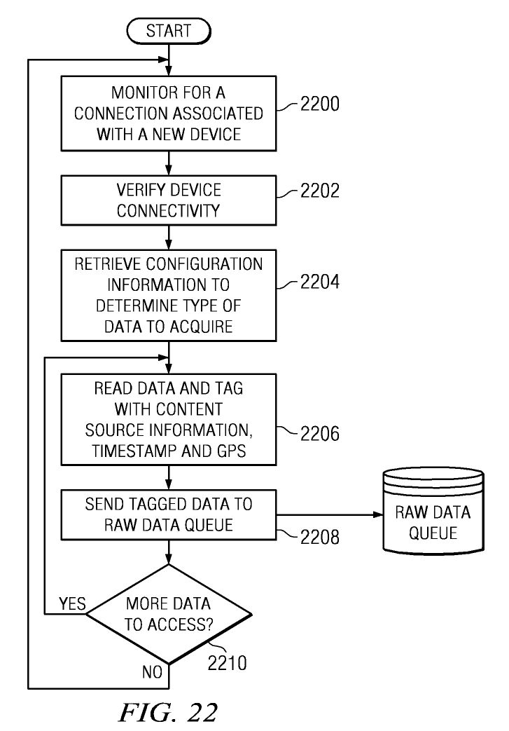

With reference to FIG. 22, a flowchart illustrating a process for acquiring and organizing personal device data is depicted in accordance with an illustrative embodiment. The process illustrated in FIG. 22 may be implemented in a digital life recording system, such as digital life recording system 300 shown in FIG. 3.

The process begins by monitoring for a connection associated with a new device (step 2200). The connection may be established either wirelessly, such as, but not limited to, Bluetooth enabled devices, or the connection may be established through a physical connection, such as, but not limited to, universal serial bus (USB) devices. The devices may include, but are not limited to, cellular phones, personal digital assistants (PDAs), and digital cameras. Responsive to detecting a connection, the process verifies the device connectivity (step 2202).

The process retrieves configuration information to determine the type of data to acquire from the connected device (step 2204). The process then reads data from the connected device(s) and tags the data with the content source information, a timestamp, and global positioning system location (step 2206). The process sends the tagged data to the raw data queue (step 2208). The process determines whether more data exists in the connected device (step 2210). In response to a determination that more data exists in the connected device, the process repeats the steps of reading and tagging the data (step 2206), and sending the tagged data to the raw data queue (step 2208). In response to a determination that more data does not exist in the connected device, the process returns to the step of monitoring for a connection associated with a new device (step 2200).

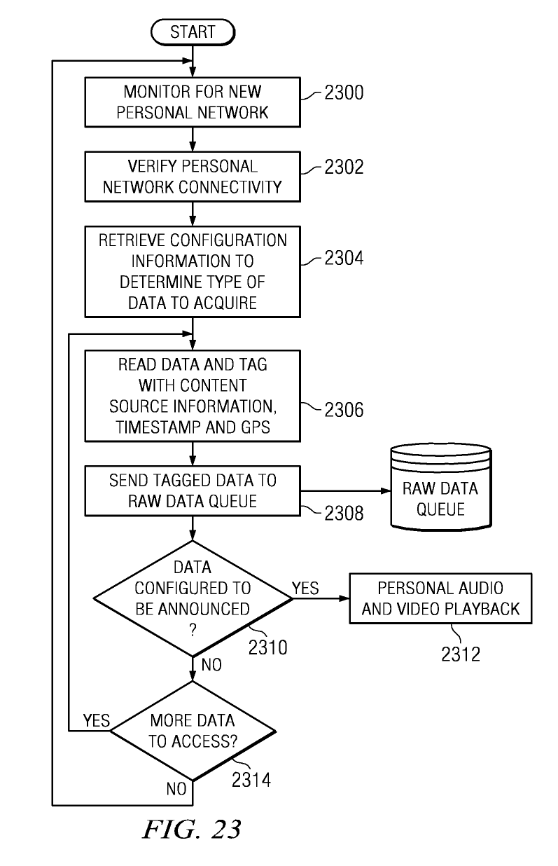

FIG. 23 is a flowchart of a process for acquiring and organizing personal network data in accordance with an illustrative embodiment. The process illustrated in FIG. 23 may be implemented in a digital life recording system, such as digital life recording system 300 shown in FIG. 3.

The process begins by monitoring for a connection associated with a new personal network (step 2300). The connection may be established either by wired or wireless means. In response to detecting a connection, the process verifies the personal network connectivity (step 2302). The process retrieves configuration information to determine the type of data to acquire from the connected personal network (step 2304).

The process then reads data from the connected personal network and tags the data with the content source information, a timestamp, and global positioning system location (step 2306). The process sends the tagged data to the raw data queue (step 2308).

The process determines whether the data is configured to be announced (step 2310). Responsive to a determination that the data is configured to be announced, the data is forwarded to a personal audio and video playback subsystem for announcing the data to the person (step 2312). The process determines whether more data exists in the connected personal network (step 2314).

In response to a determination that more data exists in the connected personal network, the process repeats the steps of reading and tagging the data (step 2306), sending the tagged data to the raw data queue (step 2308), and determining whether the data is configured to be announced (step 2310). In response to a determination that more data does not exist in the connected personal network, the process returns to the step of monitoring for a connection associated with a new personal network (step 2300).

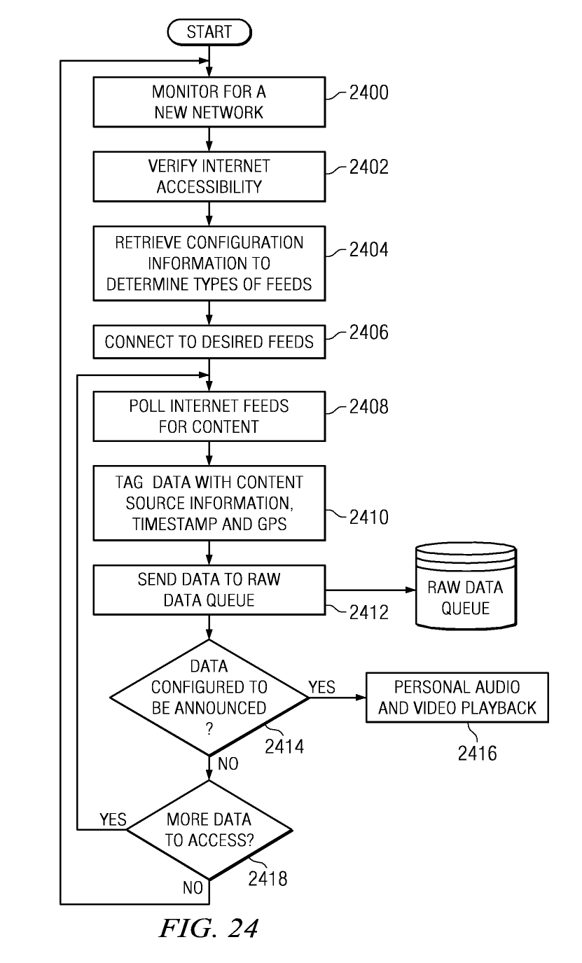

FIG. 24 is a flowchart of a process for acquiring and organizing data from the Internet in accordance with an illustrative embodiment. The process illustrated in FIG. 24 may be implemented in a digital life recording system, such as digital life recording system 300 shown in FIG. 3.

The process begins by monitoring for a connection associated with a new network (step 2400). The connection may be established either by wired or wireless means. In response to detecting a connection, the process verifies internet accessibility (step 2402). The process then retrieves configuration information to determine the types of feeds to acquire (step 2404). A feed is data created by a party and broadcast over the internet to others. The process connects to the desired feeds (step 2406) and polls the internet feeds for content (step 2408). In response to receiving data/content from the internet feeds, the data is tagged with the content source information, a timestamp, and global positioning system location (step 2410). The process sends the tagged data to the raw data queue (step 2412).

The process determines whether the data is configured to be announced (step 2414). Responsive to a determination that the data is configured to be announced, the data is forwarded to a personal audio and video playback subsystem for announcing the data to the person (step 2416). The process determines whether more data exists in the connected internet feeds (step 2418).

In response to a determination that more data exist in the connected internet feeds, the process repeats the steps of polling (step 2408) and tagging the data (step 2110), sending the tagged data to the raw data queue (step 2412), and determining whether the data is configured to be announced (step 2414). In response to a determination that more data does not exist in the connected internet feeds, the process returns to the step of monitoring for a connection associated with a new network (step 2100).

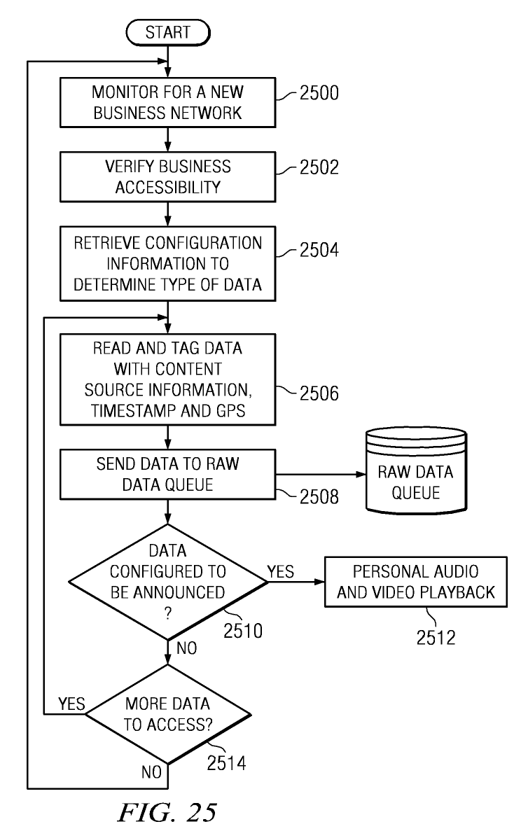

FIG. 25 is a flowchart of a process for acquiring and organizing data from business networks in accordance with an illustrative embodiment. The process illustrated in FIG. 25 may be implemented in a digital life recording system, such as digital life recording system 300 shown in FIG. 3.

The process begins by monitoring for a connection associated with a new business network (step 2500). The connection may be established either by wired or wireless means. In response to detecting a connection, the process verifies the business network connectivity (step 2502). The process retrieves configuration information to determine the type of data to acquire from the connected business network (step 2504). The process then reads data from the connected business network and tags the data with the content source information, a timestamp, and global positioning system location (step 2506). The process sends the tagged data to the raw data queue (step 2508).

The process determines whether the data is configured to be announced (step 2510). Responsive to a determination that the data is configured to be announced, the data is forwarded to a personal audio and video playback subsystem for announcing the data to the person (step 2512). The process determines whether more data exist in the connected business network (step 2514).

In response to a determination that more data exists in the connected business network, the process repeats the steps of reading and tagging the data (step 2506), sending the tagged data to the raw data queue (step 2508), and determining whether the data is configured to be announced (step 2510). In response to a determination that more data does not exist in the connected business network, the process returns to the step of monitoring for a connection associated with a new business network (step 2500).

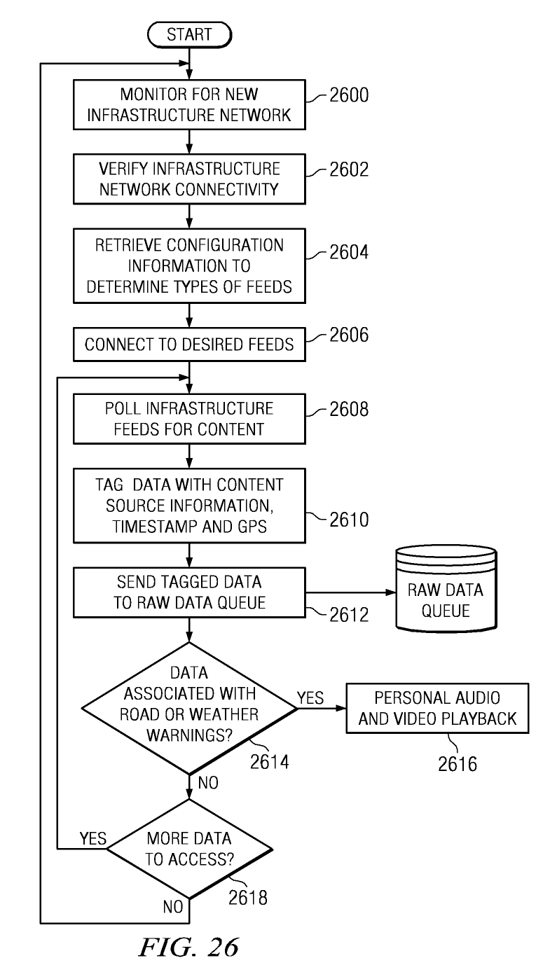

FIG. 26 is a flowchart of a process for acquiring and organizing data from infrastructure networks in accordance with an illustrative embodiment. The process illustrated in FIG. 26 may be implemented in a digital life recording system, such as digital life recording system 300 shown in FIG. 3.

The process begins by monitoring for a connection associated with a new infrastructure network (step 2600). The connection may be established either by wired or wireless means. In response to detecting a connection, the process verifies infrastructure network connectivity (step 2602). The process then retrieves configuration information to determine the types of feeds to acquire (step 2604). The types of feeds may include, but are not limited to, feeds containing data associated with weather conditions and feeds containing data associated with road conditions.

The process connects to the desired feeds (step 2606) and polls the infrastructure feeds for content (step 2608). In response to receiving data/content from the infrastructure feeds, the data is tagged with the content source information, a timestamp, and global positioning system location (step 2610). The process sends the tagged data to the raw data queue (step 2612).

The process determines whether the retrieved data contains data associated with road warnings or weather warnings related to the current location of the person (step 2614). In response to a determination that the retrieved data contains data associated with road warnings or weather warnings related to the current location of the person, the road warning/weather warning is sent to a personal audio and video playback subsystem for announcing the warning(s) to the person (step 2616).

The process determines whether more data exists in the connected infrastructure feeds (step 2618). In response to a determination that more data exists in the connected infrastructure feeds, the process repeats the steps of polling (step 2608) and tagging the data (step 2610), sending the tagged data to the raw data queue (step 2612), and determining whether the data contains data associated with road warnings or weather warnings related to the current location of the person (step 2614).

In response to a determination that more data does not exist in the connected infrastructure feeds, the process returns to the step of monitoring for a connection associated with a new infrastructure network (step 2600).

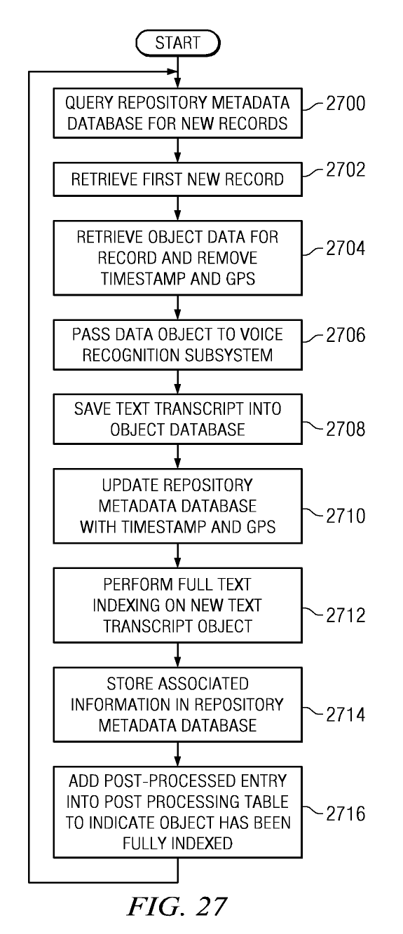

With reference now to FIG. 27, a flowchart of a process for improving the indexing of data stored in the repository mass store is depicted in accordance with an illustrative embodiment. The process illustrated in FIG. 27 may be implemented in a digital life recording system, such as digital life recording system 300 shown in FIG. 3.

The process begins by querying a repository metadata database, such as digital life metadata database 538 shown in FIG. 5, for new records (step 2700). In response to a determination that new records exist, the process retrieves the first new record (step 2702). The process retrieves the object data associated with the new record and retrieves the global positioning system (GPS) timestamp and location from the object data (step 2704). The process passes the data object to a voice recognition subsystem to generate a text transcript of the object data (step 2706).

The process saves the text transcript into an object database (step 2708), such as digital life information object database 540 shown in FIG. 5. The process then updates the repository metadata database with the global positioning system (GPS) timestamp and location, a unique identifier that points to the physical location of the text object (step 2710). The process then performs full text indexing on the new text transcript object (step 2712). The process stores the information associated with the full text indexing in the repository metadata database (step 2714). The process adds a post-processed entry, for the text transcript object, into a post processing table to indicate that the associated text transcript object has been fully indexed (step 2716). The process loops and queries the repository metadata database for a new record (step 2700).

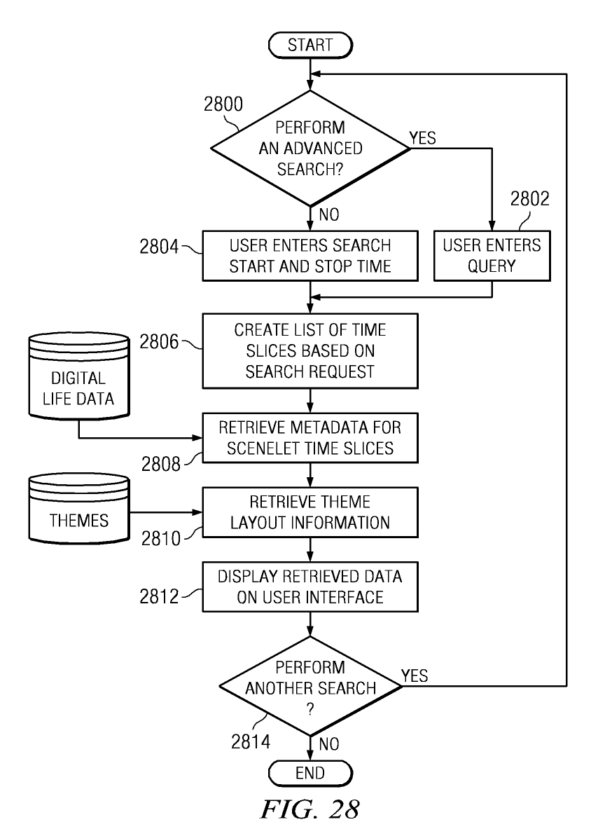

With reference now to FIG. 28, a flowchart of a process for searching, retrieving, and rendering data is depicted in accordance with an illustrative embodiment. The process illustrated in FIG. 28 may be implemented in a digital life recording system, such as digital life recording system 300 shown in FIG. 3.

The process begins by determining whether the user has selected an option to perform an advance search (step 2800). In an advance search, the process receives a query request from a user to query the repository database (step 2802). The query uses a database querying language, such as, but not limited to, structured query language (SQL). For a regular search, the process receives a request from a user containing a starting date/time and an ending date/time (step 2804). The process creates a list of time slices based on the search request (step 2806).

The process retrieves metadata for the scenelet time slices from a digital life data repository (step 2808), such as digital life data repository 804 shown in FIG. 8. The process also retrieves metadata for non-video information, such as, but not limited to, audio and temperature. The process then retrieves theme layout information from a themes database (step 2810), such as themes database 818 shown in FIG. 8. The process displays the retrieved data on a user interface (step 2812), such as user interface 900 shown in FIG. 9. The process then determines whether another search request is to be performed (step 2814). In response to determining that another search request is to be performed, the process loops back to step 2800.

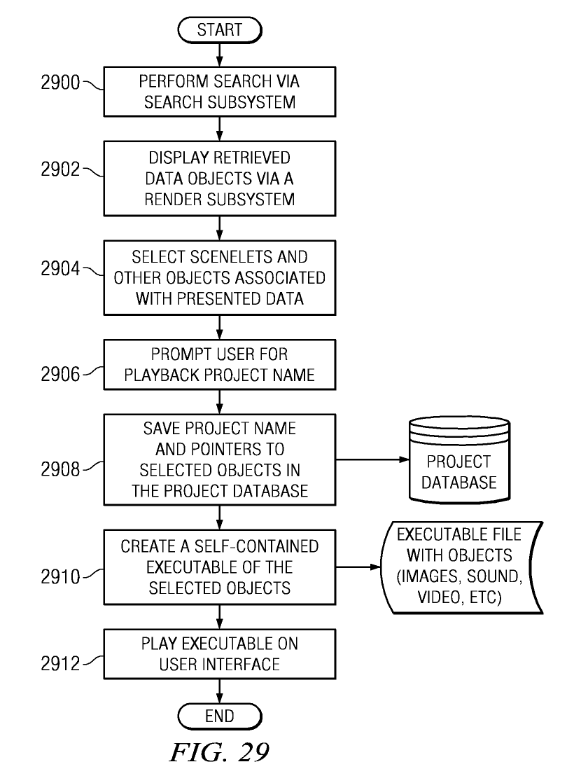

With reference now to FIG. 29, a flowchart of a process for organizing and presenting data is depicted in accordance with an illustrative embodiment. The process illustrated in FIG. 29 may be implemented in a digital life recording system, such as digital life recording system 300 shown in FIG. 3.

The process begins by performing a search for data objects via a search subsystem (step 2900), such as search subsystem 812 shown in FIG. 8. The process displays the retrieved data objects via a render subsystem (step 2902), such as render subsystem 814 shown in FIG. 8. The process selects scenelets and other objects associated with presented data (step 2904).

The process then prompts a user for a playback project name (step 2906). In response to receiving a project name from a user, the process saves the project name and pointers to the selected objects in a project definitions database (step 2908), such as project definitions database 858 shown in FIG. 8. A pointer is a variable that holds the address of a data object or function.

The process then creates a self-contained executable of the selected objects (step 2910). The self-contained executable may be emailed, posted to a web-site, or saved in non-volatile memory, such as on a hard drive. In response to a receiving a request to execute the self-contained executable of the selected objects, the process plays the self-contained executable on a user interface (step 2912), such as user interface 900 shown in FIG. 9.

Thus, the illustrative embodiments described herein provide a computer implemented method, apparatus, and computer program product for controlling the capture of data at an identified location. In one embodiment, the process identifies a location from locale identifier data to form an identified location in response to receiving the locale identifier data. The locale identifier data is associated with a location of the digital life recorder. In addition, the identified location is associated with a set of usage policies. The process then determines whether the set of usage policies restricts the capture of data by the digital life recorder at the identified location or whether the set of usage policies restricts playback of the data by a playback system. Thereafter, the process disables a set of sensors while the digital life recorder is in the presence of the locale identifier in response to determining that the set of usage policies restricts the capture of data.

The illustrative embodiments depict a system for dynamically capturing event data generated by users of a digital life recorder during the performance of daily activities. In addition, data may be captured from external sources, such as, without limitation, peer digital life recorder systems, public and private internet feeds, and information captured from broadcasts associated with businesses. The capture of data or the playback of data may be controlled by implementing a usage policy controller that governs the operation of components of a sensing subsystem of digital life recorder system. Thus, a user of the digital life recorder system may control the type of data that may be collected, stored, or replayed. In this manner, sensitive, confidential, or proprietary event data may be excluded from collection or presentation.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for controlling a capture of data by a digital life recorder, the computer implemented method comprising:
responsive to receiving locale identifier data associated with a location of the digital life recorder, identifying the location from the locale identifier data to form an identified location, wherein the identified location is associated with a set of usage policies;
determining whether the set of usage policies restricts the capture of data by the digital life recorder at the identified location or whether the set of usage policies restricts playback of the data by a playback system; and
responsive to determining that the set of usage policies restricts the capture of data, disabling a set of sensors while the digital life recorder is in the presence of a locale identifier.

2. The computer implemented method of claim 1, further comprising:
responsive to determining that the set of usage policies restricts playback of the data by the playback system, tagging the data captured at the identified location with recording restrictions specified by the set of usage policies to form tagged data, wherein a presentation of the tagged data is restricted by the playback system.

3. The computer implemented method of claim 1, wherein the set of usage policies assigned to the identified location are applied to at least one of a type of location and a specific location.

4. The computer implemented method of claim 1, wherein the set of usage policies comprises an embedded usage policy specified by the locale identifier.

5. The computer implemented method of claim 1, further comprising:
enabling the set of sensors in an absence of the locale identifier.

6. A computer program product for controlling a capture of data by a digital life recorder, the computer program product comprising:
a computer readable medium;
first program instructions for identifying a location from locale identifier data to form an identified location in response to receiving the locale identifier data, wherein the locale identifier data is associated with the location of the digital life recorder, and wherein the identified location is associated with a set of usage policies;
second program instructions for determining whether the set of usage policies restricts the capture of data by the digital life recorder at the identified location or whether the set of usage policies restricts playback of the data by a playback system;
third program instructions for disabling a set of sensors while the digital life recorder is in a presence of the locale identifier in response to determining that the set of usage policies restricts the capture of data; and
wherein the first program instructions and the second program instructions are stored on the computer readable medium.

7. The computer program product of claim 6, further comprising:
fourth program instructions for tagging the data captured at the identified location with recording restrictions specified by the set of usage policies to form tagged data in response to determining that the set of usage policies restricts playback of the data by the playback system, wherein a presentation of the tagged data is restricted by the playback system.

8. The computer program product of claim 6, wherein the set of usage policies assigned to the identified location are applied to at least one of a type of location and a specific location.

9. The computer program product of claim 6, wherein the set of usage policies comprises an embedded usage policy specified by the locale identifier.

10. The computer program product of claim 6, further comprising:
fifth program instructions for enabling the set of sensors in an absence of the locale identifier.

11. An apparatus for controlling a capture of data by a digital life recorder, the apparatus comprising:
a bus system;
a memory connected to the bus system, wherein the memory includes computer usable program code; and
a processing unit connected to the bus system, wherein the processing unit executes the computer usable program code to identify a location from locale identifier data to form an identified location in response to receiving the locale identifier data, wherein the locale identifier data is associated with the location of the digital life recorder, and wherein the identified location is associated with a set of usage policies; determine whether the set of usage policies restricts the capture of data by the digital life recorder at the identified location or whether the set of usage policies restricts playback of the data by a playback system; and disable a set of sensors while the digital life recorder is in a presence of the locale identifier in response to determining that the set of usage policies restricts the capture of data.

12. The apparatus of claim 11, wherein the processing unit further executes the computer usable program code to tag the data captured at the identified location with recording restrictions specified by the set of usage policies to form tagged data in response to determining that the set of usage policies restricts playback of the data by the playback system, wherein a presentation of the tagged data is restricted by the playback system.

13. The apparatus of claim 11, wherein the set of usage policies assigned to the identified location are applied to at least one of a type of location and a specific location.

14. The apparatus of claim 11, wherein the set of usage policies comprises an embedded usage policy specified by the locale identifier.

15. The apparatus of claim 11, wherein the processing unit further executes the computer usable program code to enable the set of sensors in an absence of the locale identifier.

16. A system for controlling a capture of data by a digital life recorder, the system comprising:
a locale identifier sensor, wherein the locale identifier sensor detects a presence of a locale identifier, and wherein the locale identifier is present in an identified location;
a usage policy controller, wherein the usage policy controller identifies a location from locale identifier data to form an identified location in response to receiving the locale identifier data, wherein the locale identifier data is associated with a location of the digital life recorder, and wherein the identified location is associated with a set of usage policies; determines whether the set of usage policies restricts the capture of data by the digital life recorder at the identified location or whether the set of usage policies restricts playback of the data by a playback system; and disables a set of sensors while the digital life recorder is in a presence of the locale identifier in response to determining that the set of usage policies restricts the capture of data.

17. The system of claim 16, wherein the usage policy controller tags the data captured at the identified location with recording restrictions specified by the set of usage policies to form tagged data in response to determining that the set of usage policies restricts playback of the data by the playback system, wherein a presentation of the tagged data is restricted by the playback system.

18. The system of claim 16, wherein the set of usage policies comprises an embedded usage policy specified by the locale identifier.

19. The system of claim 16, wherein the usage policy controller enables the set of sensors in an absence of the locale identifier.

20. The system of claim 16, wherein the locale identifier is a radio frequency identification tag, and wherein the locale identifier sensor is a radio frequency identification tag reader.
